(19) United States
(12) Patent Application Publication
(10) Pub. No.: US 2024/0379311 A1
(43) Pub. Date: Nov. 14, 2024

(54) ELECTROMAGNETIC RELAY

(71) Applicant: Panasonic Intellectual Property Management Co., Ltd., Osaka (JP)

(72) Inventors: Ryo YAMANAKA, Osaka (JP); Akihiro OKUDA, Mie (JP); Tsubasa MORITA, Mie (JP); Sota NISHIMURA, Tochigi (JP)

(21) Appl. No.: 18/690,966

(22) PCT Filed: Jul. 20, 2022
(86) PCT No.: PCT/JP2022/028251

§ 371 Date: Mar. 11, 2024

(30) Foreign Application Priority Data
Sep. 30, 2021 (JP) 2021-162221

(51) Int. Cl. H01H 50/04; H01H 50/14; H01H 50/26; H01H 50/44; H01H 50/58; H01H 50/64

(52) U.S. Cl. CPC H01H 50/045; H01H 50/14; H01H 50/26; H01H 50/443; H01H 50/58; H01H 50/642

(57) ABSTRACT

An electromagnetic relay includes: a coil; a bobbin; a core inserted into the bobbin; an armature; a first fixed contact; a first movable spring including a first movable contact configured to cause the first movable contact to move into and out of contact with the first fixed contact; a second fixed contact; a second movable spring including a second movable contact configured to cause the second movable contact to move into and out of contact with the second fixed contact; and a card configured to cause the second movable contact to move into or out of contact with the second fixed contact according to switching of the coil between an excited state and a non-excited state. The first movable spring includes a first end portion near the first end of the armature and a second end portion farther from the first end of the armature.

### TECHNICAL FIELD

The present disclosure generally relates to electromagnetic relays and more particularly relates to an electromagnetic relay including two contact devices each including a fixed contact and a movable contact.

### BACKGROUND ART

Patent Literature (PTL) 1 discloses an electromagnetic relay. The electromagnetic relay disclosed in PTL 1 includes a fixed terminal, a movable terminal, an auxiliary fixed terminal, an auxiliary movable terminal, an armature, an electromagnet, and a return spring.

The fixed terminal includes an external input/output terminal and an external output/input terminal. The movable terminal can electrically connect the external input/output terminal and the external output/input terminal. The auxiliary fixed terminal includes an auxiliary external input/output terminal and an auxiliary external output/input terminal. The auxiliary movable terminal can electrically connect the auxiliary external input/output terminal and the auxiliary external output/input terminal.

The armature moves each of the movable terminal and the auxiliary movable terminal so as to switch the auxiliary movable terminal between electrical connection and disconnection with respect to each of the auxiliary external input/output terminal and the auxiliary external output/input terminal when switching the movable terminal between electrical connection and disconnection with respect to each of the external input/output terminal and the external output/input terminal.

The electromagnet generates electromagnetic force for driving the armature to move the movable terminal and the auxiliary movable terminal. When the electromagnet stops generating electromagnetic force, the armature is returned to the original position by the return force of the return spring.

### CITATION LIST

### Patent Literature

PTL 1: Unexamined Japanese Patent Publication No. 2015-115248

### SUMMARY OF INVENTION

There are cases where it is desired that an electromagnetic relay have a simplified structure.

An object of the present disclosure is to simplify the structure.

An electromagnetic relay according to one aspect of the present disclosure includes: a coil; a bobbin on which the coil is wound; a core extending in an up-down direction and being inserted into the bobbin; an armature disposed above the core; a first fixed contact; a first movable spring including a first movable contact facing the first fixed contact, the first movable spring being configured to cause the first movable contact to move into and out of contact with the first fixed contact; a second fixed contact; a second movable spring including a second movable contact facing the second fixed contact, the second movable spring being configured to cause the second movable contact to move into and out of contact with the second fixed contact; and a card configured to cause the second movable contact to move into contact with the second fixed contact or cause the second movable contact to move out of contact with the second fixed contact according to switching of the coil between an excited state and a non-excited state, wherein the first movable spring is fixed above the armature, the armature includes a first end and a second end, the first movable spring includes a first end portion that is near the first end of the armature and a second end portion that is farther from the first end of the armature than the first end portion is, the first movable contact is disposed on the first end portion of the first movable spring, and the card is disposed facing the second end of the armature.

The present disclosure is advantageous in that the structure can be simplified.

### BRIEF DESCRIPTION OF DRAWINGS

FIG. 1 is a perspective view of an electromagnetic relay according to an exemplary embodiment.

FIG. 2 is an exploded perspective view of the electromagnetic relay.

FIG. 3 is an exploded perspective view of a relay body included in the electromagnetic relay.

FIG. 4 is an exploded perspective view of a main block included in the relay body.

FIG. 5 is an exploded perspective view of an electromagnet block included in the main block.

FIG. 6 is a top view of a bobbin included in the electromagnet block.

FIG. 7 is a perspective view of the bobbin.

FIG. 8 is a perspective view of an insulating member included in the electromagnet block.

FIG. 9 is an exploded perspective view of a movable block included in the main block.

FIG. 10 is an exploded perspective view of a first block included in the relay body.

FIG. 11 is a perspective view of a first holding mount included in the first block.

FIG. 12 is an exploded perspective view of a second block included in the relay body.

FIG. 13 is a perspective view of a second holding mount included in the second block.

FIG. 14A is a left side view of the relay body during de-energization.

FIG. 14B is a left side view of the relay body during energization.

FIG. 15A is a right side view of the relay body during de-energization.

FIG. 15B is a right side view of the relay body during energization.

FIG. 16 is a perspective view of a case included in the electromagnetic relay.

FIG. 17 is a cross-sectional view of the electromagnetic relay during energization.

FIG. 18 is a cross-sectional view of the electromagnetic relay during energization.

FIG. 19A is a right side view of a relay body included in an electromagnetic relay according to Variation 1 during de-energization.

FIG. 19B is a right side view of the relay body during energization.

FIG. 20 is a partially sectioned side view of an electromagnetic relay according to Variation 2.

### DESCRIPTION OF EMBODIMENTS

An electromagnetic relay according to an exemplary embodiment of the present disclosure will be described with reference to the drawings. Each figure described in the following exemplary embodiment is a schematic diagram, meaning that the ratio between the sizes of structural elements in each figure and the ratio between the thicknesses of structural elements in each figure do not necessarily reflect an actual dimension ratio.

In the present disclosure, there are cases where terms indicating directions such as “up/upper/above/top”, “down/lower/below/bottom”, “left”, “right”, “front/forward”, and “back/backward/rear/rearward” are used in the description. These directions merely indicate relative positioning and do not limit the present disclosure. For example, when electromagnetic relay 100 according to the present disclosure is rotated upon installation, the direction of electromagnetic relay 100 when in actual use and the direction of electromagnetic relay 100 described in the present disclosure may be different.

### (1) Outline

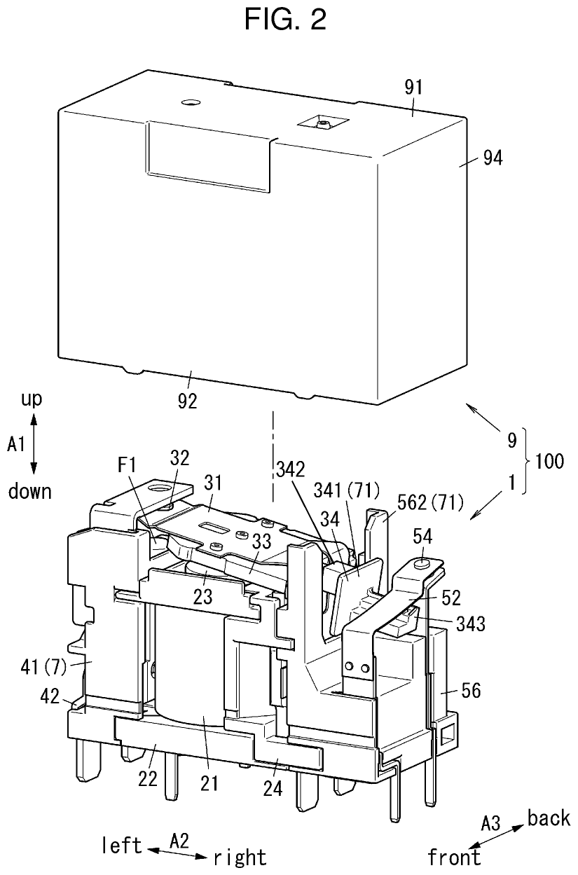

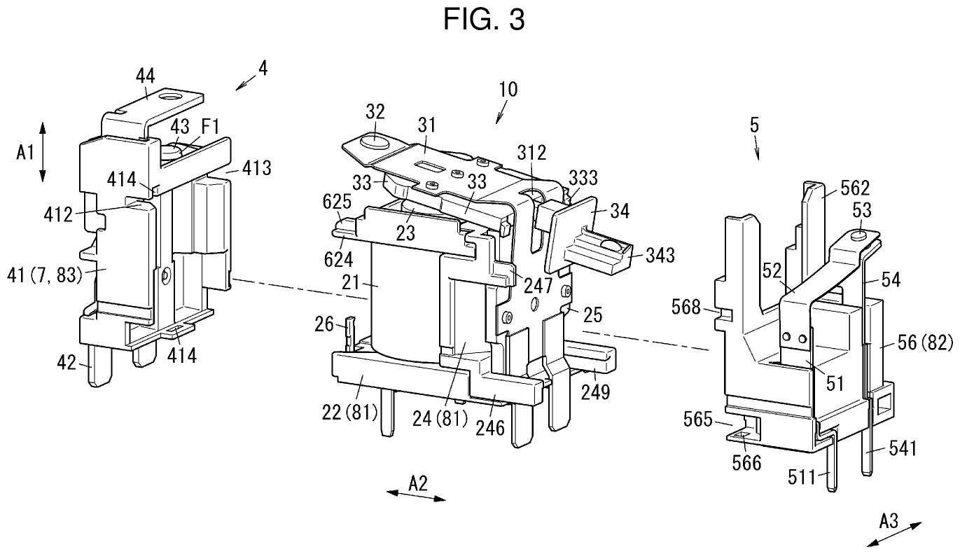

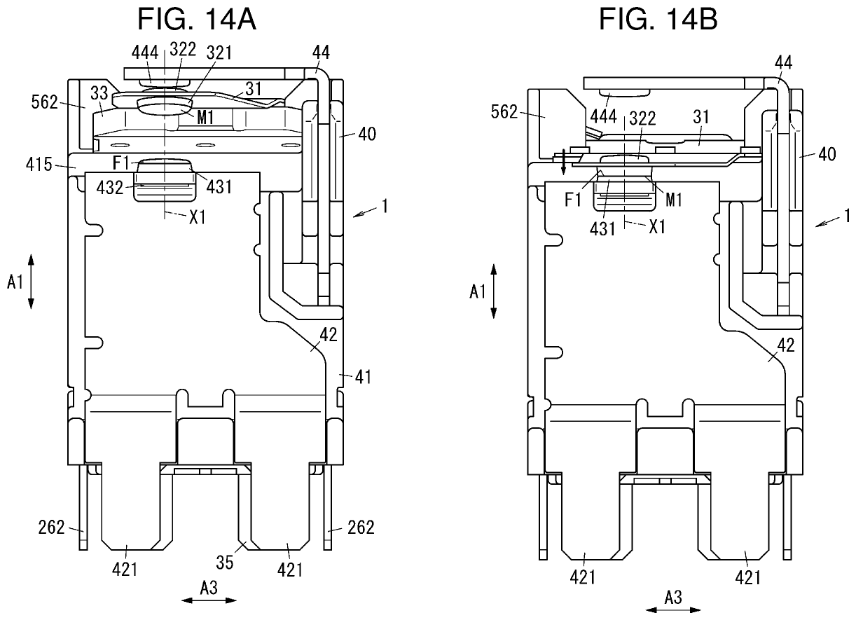

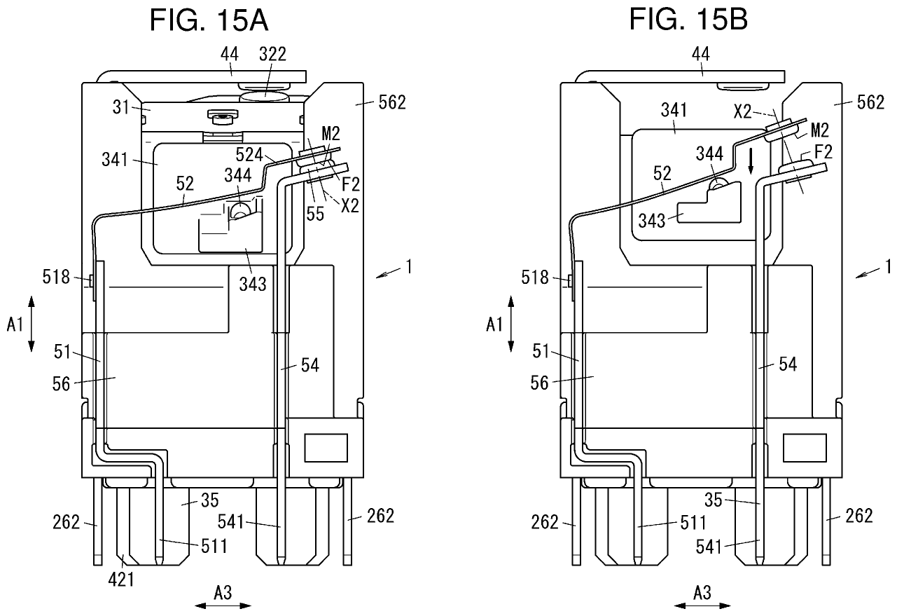

As illustrated in FIG. 2, FIG. 3, FIG. 14A, and FIG. 15A, electromagnetic relay 100 according to the present exemplary embodiment includes coil 21, bobbin 22, core 23, armature 33, first fixed contact F1, first movable spring 31, second fixed contact F2, second movable spring 52, and card 34.

Coil 21 is wound on bobbin 22. Core 23 is inserted into coil 21 in the up-down direction along first axis A1. Armature 33 has a lower surface facing the upper surface of core 23. First movable spring 31 includes first movable contact M1. First movable contact M1 faces first fixed contact F1 along first axis A1 and moves into and out of contact with first fixed contact F1. Second movable spring 52 includes second movable contact M2. Second movable contact M2 faces second fixed contact F2 and moves into and out of contact with second fixed contact F2. Card 34 causes second movable contact M2 to move into and out of contact with second fixed contact F2 according to switching of coil 21 between the excited state and the non-excited state.

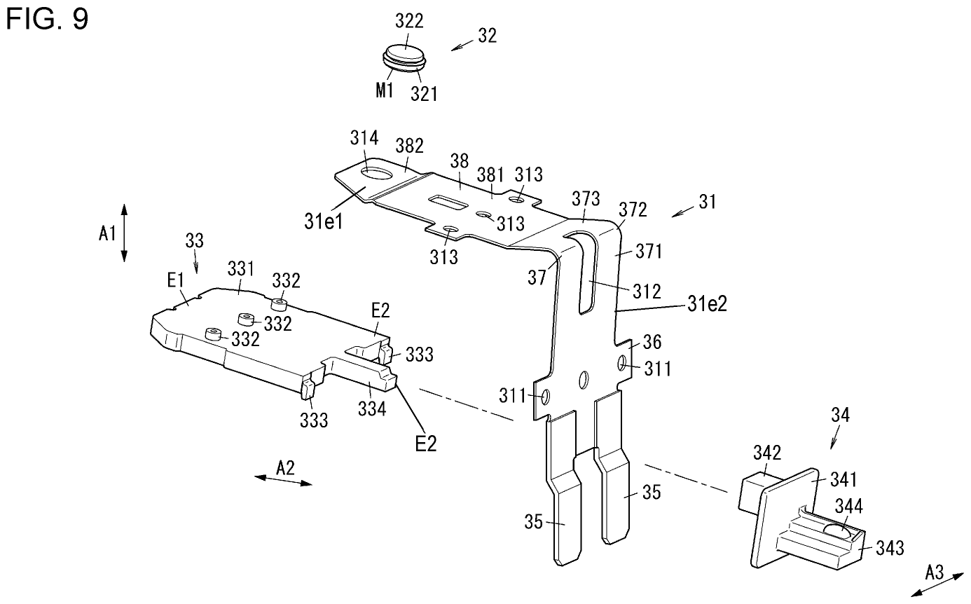

First movable spring 31 is fixed to the upper surface of armature 33. Armature 33 includes first end E1 and second end E2 (refer to FIG. 9) which are opposite ends as viewed from above. First movable contact M1 is provided on first movable spring 31, on the side on which first end E1 of armature 33 is located, as viewed from above. Card 34 is provided on the side on which second end E2 of armature 33 is located, as viewed from above.

In electromagnetic relay 100 according to the present exemplary embodiment, first movable contact M1 is provided on first movable spring 31, and first movable spring 31 is fixed to armature 33. Therefore, first movable contact M1 moves by the spring force of first movable spring 31 and the force of attraction exerted by core 23 onto armature 33. This allows electromagnetic relay 100 according to the present exemplary embodiment to have a simplified structure as compared to an electromagnetic relay according to a comparative example that includes a member (a return spring) that moves first movable contact M1 in addition to a member on which first movable contact M1 is provided, for example.

Furthermore, in electromagnetic relay 100 according to the present exemplary embodiment, first movable spring 31 is fixed to the upper surface of armature 33. Therefore, when first movable contact M1 is provided on the lower surface of first movable spring 31, first movable contact M1 can be brought into contact with first fixed contact F1 using the force of attraction exerted by core 23 onto armature 33 along first axis A1. Accordingly, the contact pressure between first movable contact M1 and first fixed contact F1 can be increased.

Furthermore, in electromagnetic relay 100 according to the present exemplary embodiment, first movable contact M1 is provided on first movable spring 31, on the side on which first end E1 of armature 33 is located, and card 34 that causes second movable contact M2 to move into and out of contact with second fixed contact F2 is provided on the side on which second end E2 of armature 33 is located, as illustrated in FIG. 9. In other words, as illustrated in FIG. 9, first movable spring 31 includes: first end portion 31e1 that is near first end E1 of armature 33; and second end portion 31e2 that is farther from first end E1 of armature 33 (closer to second end E2 of armature 33) than first end portion 31e1 is. First movable contact M1 is provided on first end portion 31e1 of first movable spring 31, and card 34 is disposed facing second end E2 of armature 33. Therefore, the distance between first movable contact M1 and second movable contact M2 can be increased. This makes it possible to reduce the likelihood that an electric arc that may be generated at first movable contact M1 will affect second movable contact M2 and the likelihood that an electric arc that may be generated at second movable contact M2 will affect first movable contact M1, for example.

### (2) Details

Hereinafter, electromagnetic relay 100 according to the present exemplary embodiment will be described in detail with reference to the drawings.

Electromagnetic relay 100 is what is called a hinged relay. Electromagnetic relay 100 includes: a first contact device including first movable contact M1 and first fixed contact F1; and a second contact device including second movable contact M2 and second fixed contact F2. An electrically conductive component that is electrically connected to the first contact device and an electrically conductive component that is electrically connected to the second contact device are electrically insulated.

Electromagnetic relay 100 is mounted on an electric vehicle, for example. Electromagnetic relay 100 is used to turn ON/OFF a charging cable circuit in an electric vehicle, for example. The first contact device is inserted into the charging cable circuit.

The second contact device is used for monitoring the state of the first contact device, for example, detecting a welded state.

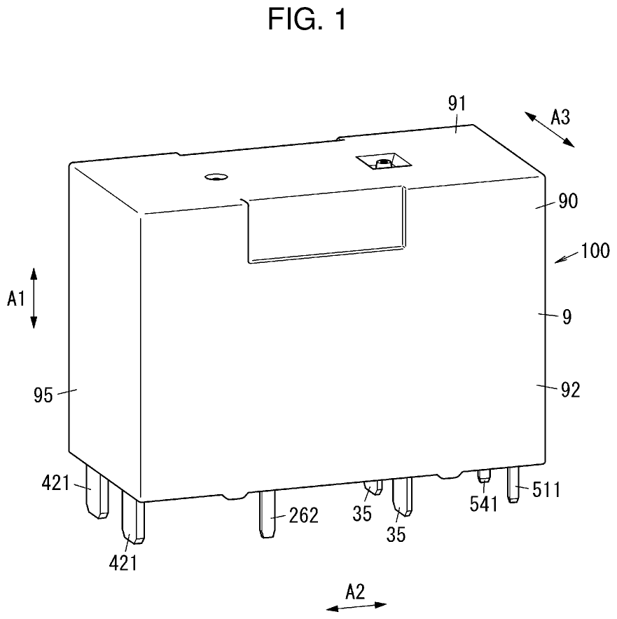

As illustrated in FIG. 1 and FIG. 2, electromagnetic relay 100 includes relay body 1 and case 9.

As illustrated in FIG. 2 to FIG. 4, relay body 1 is formed by combining a plurality of blocks together. Relay body 1, which includes electromagnet block 2, movable block 3, first block (fixed block) 4, and second block (auxiliary block) 5, is formed by combining these elements. Electromagnetic block 2 combined with movable block 3 may be hereinafter referred to as main block 10 (refer to FIG. 3).

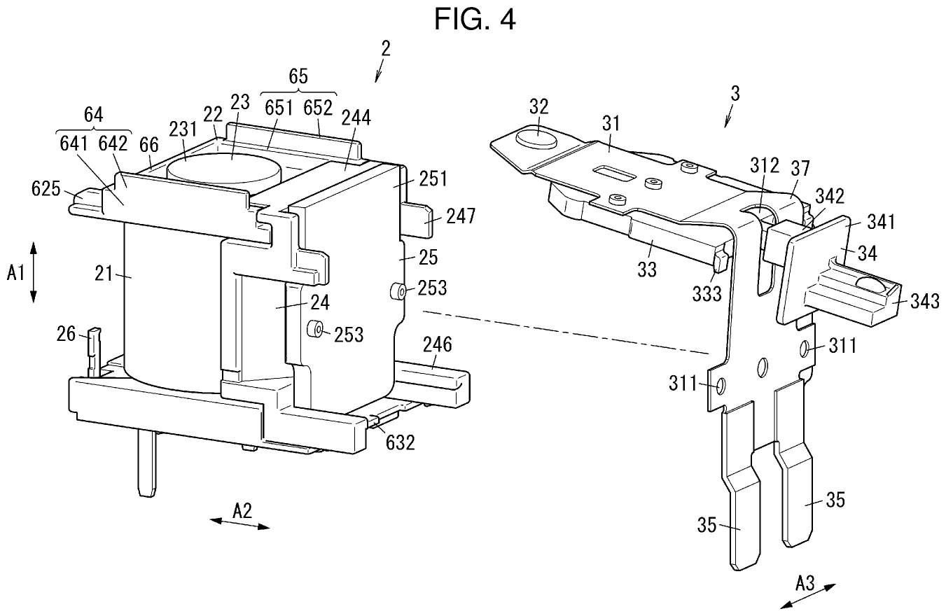

As illustrated in FIG. 3 and FIG. 4, main block 10 includes coil 21, core 23 inserted into coil 21, and armature 33.

Hereinafter, a virtual axis extending along core 23 will also be referred to as first axis A1. Armature 33 is located side by side with core 23 along first axis A1. A virtual axis along which main block 10 and first block 4 are arranged side by side will also be referred to as second axis A2. Second axis A2, which crosses first axis A1, is orthogonal thereto in the present exemplary embodiment. A virtual axis crossing both first axis A1 and second axis A2 will also be referred to as third axis A3. In the present exemplary embodiment, third axis A3 crosses both first axis A1 and second axis A2. The side on which armature 33 is located as viewed from core 23 along first axis A1 is also referred to as “up”, and the side on which core 23 is located as viewed from armature 33 along first axis A1 is also referred to as “down”. The side on which first block 4 is located as viewed from main block 10 along second axis A2 is also referred to as “left”, and the side on which main block 10 is located as viewed from first block 4 along second axis A2 is also referred to as “right”. The opposite sides along third axis A3 are also referred to as “front” and “back”.

In the present disclosure, the phrase “as viewed from above” refers to being seen from above along first axis A1, the phrase “as viewed from the side” refers to being seen from the left or right side along second axis A2, and the phrase “as viewed from the front” refers to being seen from the front along third axis A3.

As illustrated in FIG. 3, first block 4 is fitted to main block 10 from the left side along second axis A2 and is fixed to main block 10. Second block 5 is fitted to main block 10 from the right side along second axis A2 and is fixed to main block 10. Note that in the present disclosure, the phrase “being fixed” may have both the meaning of being fixed in a detachable manner by engagement or the like and the meaning of being fixed in a non-detachable manner by bonding, welding, or the like.

### (2.1) Electromagnet Block

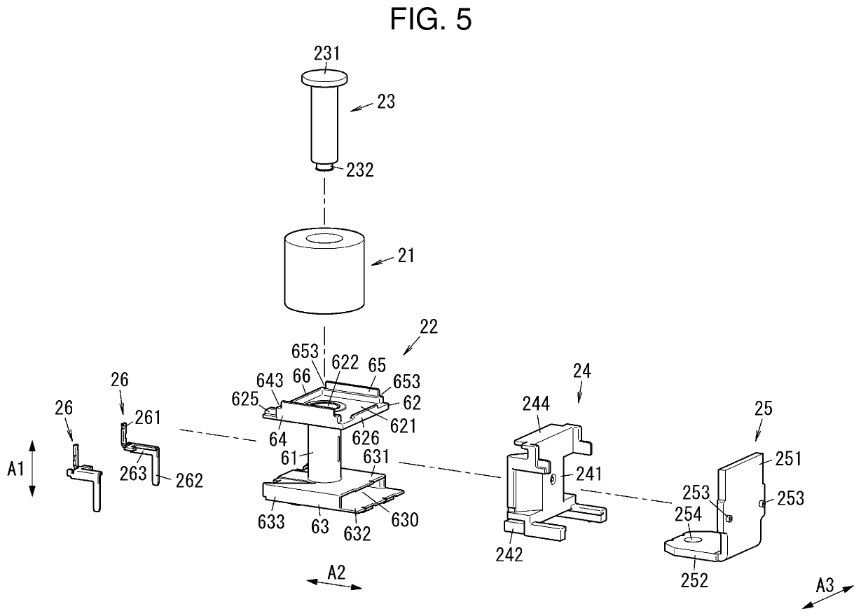

As illustrated in FIG. 4 and FIG. 5, electromagnet block 2 includes coil 21, bobbin 22, core 23, insulating member 24, yoke 25, and two coil terminals 26.

As illustrated in FIG. 5, bobbin 22 includes: body portion 61; upper flange portion 62 provided above body portion 61; and lower flange portion 63 provided below body portion 61. Body portion 61, upper flange portion 62, and lower flange portion 63 are integrally formed as a molded body made of a synthetic resin having electrical insulation properties.

Body portion 61 is in the shape of a hollow cylinder having an axis extending along first axis A1. Coil 21 is wound on body portion 61. The axis of coil 21 (a virtual axis around which the winding of coil 21 is wound) substantially matches the axis of body portion 61.

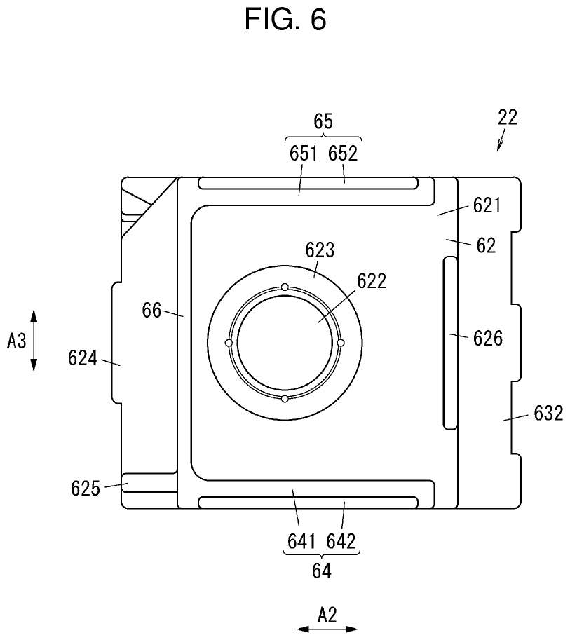

As illustrated in FIG. 5 and FIG. 6, upper flange portion 62 includes upper flange body 621 in the shape of a board that is approximately rectangular as viewed from above. Upper flange body 621 has, at a position to the left of the center thereof, circular hole 622 leading to the internal space of body portion 61. On the upper surface of upper flange body 621, ring-shaped pedestal portion 623 protruding upward is provided around hole 622.

Upper flange portion 62 includes first wall portion 64, second wall portion 65, and third wall portion 66 on the upper surface of upper flange body 621.

First wall portion 64 is provided along the first side (the front side) of upper flange body 621 that extends along second axis A2. First wall portion 64 protrudes upward from the upper surface of upper flange body 621. First wall portion 64 is continuously formed along second axis A2. First wall portion 64 is provided at a position overlapping a virtual line extending forward from the center of hole 622 of upper flange body 621 along third axis A3.

First wall portion 64 includes: base 641 formed on the upper surface of upper flange body 621; and protruding rib 642 formed on the upper surface of base 641. Base 641 is in the approximate shape of a cuboid extending along second axis A2. Protruding rib 642 is in the approximate shape of a protruding strip extending along second axis A2.

The thickness of protruding rib 642 (the dimension thereof along third axis A3) is less than the thickness of base 641. The front surface (the outer surface) of base 641 and the front surface of protruding rib 642 are flush with each other (located on the same plane). Therefore, there is a step between the rear surface (the inner surface) of protruding rib 642 and base 641.

The length of protruding rib 642 (the dimension thereof along second axis A2) is less than the length of base 641. Protruding rib 642 is located at the approximate center of the upper surface of base 641 along second axis A2. Therefore, there is a step between the left side surface of protruding rib 642 and base 641, and there is a step between the right side surface of protruding rib 642 and base 641. As just described, first wall portion 64 includes first recessed portion 643 depressed along first axis A1. First wall portion 64 includes, as first recessed portions 643, two first recessed portions 643 located at opposite ends (the left end and the right end) of first wall portion 64 along second axis A2.

Second wall portion 65 is provided along the second side (the back side) of upper flange body 621 that extends along second axis A2. Second wall portion 65 protrudes upward from the upper surface of upper flange body 621. Second wall portion 65 is continuously formed along second axis A2. Second wall portion 65 is provided at a position overlapping a virtual line extending backward from the center of hole 622 of upper flange body 621 along third axis A3.

Second wall portion 65 opposes first wall portion 64 across hole 622 along third axis A3. First wall portion 64 and second wall portion 65 are symmetrical as viewed from above.

Second wall portion 65 includes: base 651 formed on the upper surface of upper flange body 621; and protruding rib 652 formed on the upper surface of base 651. Base 651 is in the approximate shape of a cuboid extending along second axis A2. Protruding rib 652 is in the approximate shape of a protruding strip extending along second axis A2.

The thickness of protruding rib 652 (the dimension thereof along third axis A3) is less than the thickness of base 651. The rear surface (the outer surface) of base 651 and the rear surface of protruding rib 652 are flush with each other (located on the same plane). Therefore, there is a step between the front surface (the inner surface) of protruding rib 652 and base 651.

The length of protruding rib 652 (the dimension thereof along second axis A2) is less than the length of base 651. Protruding rib 652 is located at the approximate center of the upper surface of base 651 along second axis A2. Therefore, there is a step between the left side surface of protruding rib 652 and base 651, and there is a step between the right side surface of protruding rib 652 and base 651. As just described, second wall portion 65 includes second recessed portion 653 depressed along first axis A1. Second wall portion 65 includes, as second recessed portion 653, two second recessed portions 653 located at opposite ends (the left end and the right end) of second wall portion 65 along second axis A2.

Third wall portion 66 is provided on the upper surface of upper flange body 621 along third axis A3. Third wall portion 66 is provided along the third side (the left side) of upper flange body 621 that extends along third axis A3. Third wall portion 66 protrudes upward from the upper surface of upper flange body 621. Third wall portion 66 is located to the left of hole 622.

Third wall portion 66 is in the approximate shape of a cuboid extending along third axis A3. The height of third wall portion 66 (the dimension thereof along first axis A1) is substantially equal to the height of base 641 of first wall portion 64 and is substantially equal to the height of base 651 of second wall portion 65.

Third wall portion 66 connects the first end (the left end) of first wall portion 64 and the first end (the left end) of second wall portion 65 to each other. More specifically, third wall portion 66 connects the rear surface of the first end (the left end) of base 641 of first wall portion 64 and the front surface of the first end (the left end) of base 651 of second wall portion 65 to each other. Third wall portion 66 is continuously formed along third axis A3. In upper flange portion 62, first wall portion 64, second wall portion 65, and third wall portion 66 form a C-shape as viewed from above.

As illustrated in FIG. 5 and FIG. 6, upper flange portion 62 further includes protruding board portion 624, holding protrusion 625, and positioning portion 626.

Protruding board portion 624 is in the shape of a board protruding to the left from the third side (the left side) of upper flange body 621 along second axis A2. Protruding board portion 624 is located on the same plane as upper flange body 621.

Holding protrusion 625 is provided on the upper surface of protruding board portion 624. Holding protrusion 625 is a rib extending along second axis A2, at a position near the front end on the upper surface of protruding board portion 624. One end of holding protrusion 625 is connected to the left side surface of third wall portion 66.

Positioning portion 626 is a protrusion provided on the upper surface of upper flange body 621 along third axis A3. Positioning portion 626 is provided along the fourth side (the right side) of upper flange body 621 that extends along third axis A3. The length of positioning portion 626 (the dimension thereof along third axis A3) is less than the length of the fourth side (the right side) of upper flange body 621. Positioning portion 626 is provided at the center of the fourth side (the right side) of upper flange body 621 along third axis A3. The first end (the front end) of positioning portion 626 and the second end (the right end) of first wall portion 64 are not connected, and there is a space therebetween. The second end (the rear end) of positioning portion 626 and the second end (the right end) of second wall portion 65 are not connected, and there is a space therebetween.

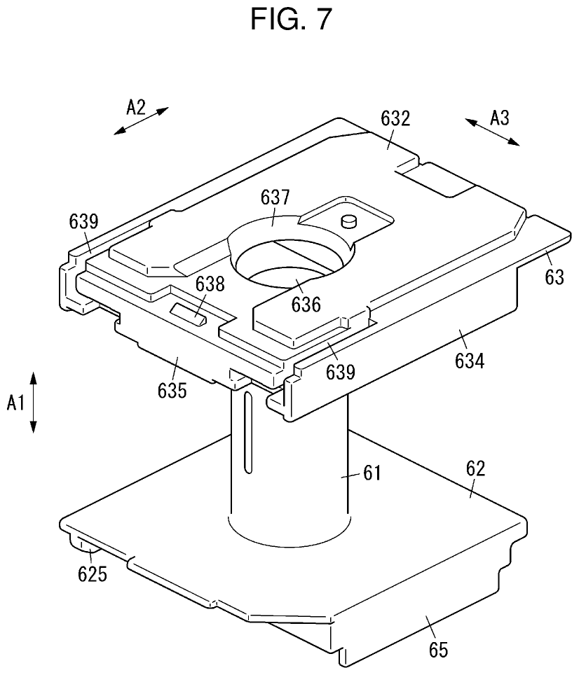

As illustrated in FIG. 5 and FIG. 7, lower flange portion 63 includes upper wall portion 631, lower wall portion 632, front wall portion 633, rear wall portion 634, and left wall portion 635. Lower flange portion 63 is formed in the shape of a hollow rectangular box. Lower flange portion 63 is open on one lateral side (the right lateral side) along second axis A2. In other words, lower flange portion 63 includes opening portion 630 on the right lateral side.

Upper wall portion 631 is in the shape of a board that is approximately rectangular as viewed from above. Upper wall portion 631 has, at the center thereof, circular hole 636 connecting the internal space of body portion 61 and the internal space of lower flange portion 63.

Lower wall portion 632 is in the shape of a board that is approximately rectangular as viewed from above. Lower wall portion 632 has, at the center thereof, circular hole 637 connecting the internal space of lower flange portion 63 and an external space. The center of hole 637 of lower wall portion 632 and the center of hole 636 of upper wall portion 631 substantially match as viewed from above.

The length of lower wall portion 632 (the dimension thereof along second axis A2) is greater than the length of upper wall portion 631. The right end of lower wall portion 632 protrudes farther to the right than the right end of upper wall portion 631 as viewed from above.

Engagement protrusion 638 protruding downward is provided at a position on the left end of the lower surface of lower wall portion 632 that is at the center thereof along third axis A3.

Each of front wall portion 633 and rear wall portion 634 is in the shape of a board that is approximately rectangular as viewed from the front. Front wall portion 633 connects the front edge of upper wall portion 631 and the front edge of lower wall portion 632 to each other. Rear wall portion 634 connects the rear edge of upper wall portion 631 and the rear edge of lower wall portion 632 to each other.

Left wall portion 635 is in the shape of a board that is approximately rectangular as viewed from the side. Left wall portion 635 connects the left edge of upper wall portion 631 and the left edge of lower wall portion 632 to each other.

Lower flange portion 63 includes two holding grooves 639 for attaching two coil terminals 26 to end portions (the front end portion and the rear end portion) that are located at the left end and opposite along third axis A3. Holding grooves 639 are formed continuously on upper wall portion 631, left wall portion 635, and lower wall portion 632.

As illustrated in FIG. 4 and FIG. 5, two coil terminals 26 are inserted into two holding grooves 639 of lower flange portion 63 and thus held on lower flange portion 63. One of two coil terminals 26 is connected to the first end of coil 21, and the other is connected to the second end of coil 21.

As illustrated in FIG. 5, coil terminal 26 includes: first terminal portion 261 connected to coil 21; second terminal portion 262 connected to an external device; and joining portion 263 connecting first terminal portion 261 and second terminal portion 262. First terminal portion 261 protrudes upward from upper wall portion 631 of lower flange portion 63. Second terminal portion 262 protrudes downward from lower wall portion 632 of lower flange portion 63. As illustrated in FIG. 1, second terminal portion 262 is exposed on the bottom of case 9.

As illustrated in FIG. 5, core 23 is formed in the shape of a cylinder. Core 23 is inserted into bobbin 22 in the up-down direction along first axis A1. Core 23 is inserted into body portion 61 of bobbin 22. Core 23 includes disc-shaped magnetic pole portion 231 at one end (the upper end) along first axis A1. As illustrated in FIG. 4, magnetic pole portion 231 is exposed on the top of bobbin 22. The lower surface of magnetic pole portion 231 is supported on pedestal portion 623 of upper flange portion 62 of bobbin 22. Core 23 includes, at a lower end portion, small-diameter portion 232 having a relatively small diameter.

As illustrated in FIG. 4 and FIG. 5, coil 21 is wound on bobbin 22. Coil 21 is wound around body portion 61 of bobbin 22. Therefore, coil 21 is wound around core 23.

The first end of coil 21 is connected to one of two coil terminals 26, and the second end of coil 21 is connected to the other of two coil terminals 26.

As illustrated in FIG. 5, yoke 25 includes first yoke 251 and second yoke 252.

First yoke 251 is in the shape of a rectangular board extending along first axis A1. Second yoke 252 is in the shape of a rectangular board extending along second axis A2. The lower end of first yoke 251 is connected to the right end of second yoke 252, and first yoke 251 and the second yoke form an inverted L-shape as viewed from the front.

First yoke 251 includes, at ends (the front end portion and the rear end portion) of the right surface thereof that are opposite along third axis A3, two fixing protrusions 253 for fixing first movable spring 31. Fixing protrusion 253 can be formed, for example, by pushing, from the left to the right, a portion of the left surface of first yoke 251 that corresponds to fixing protrusion 253.

Second yoke 252 has through-hole 254. Through-hole 254 extends through second yoke 252 along first axis A1.

As illustrated in FIG. 4, first yoke 251 is placed to the right of coil 21. Second yoke 252 is inserted from the right side into the internal space of lower flange portion 63 of bobbin 22 through opening portion 630. Subsequently, core 23 (more specifically, small-diameter portion 232) is inserted from above into through-hole 254 of second yoke 252. Yoke 25 forms a magnetic circuit together with core 23.

The length of first yoke 251 (the dimension thereof along first axis A1) is greater than the distance between upper flange portion 62 (upper flange body 621) and lower flange portion 63 (upper wall portion 631) of bobbin 22. The width of first yoke 251 (the dimension thereof along third axis A3) is substantially equal to the diameter of coil 21. First yoke 251 covers substantially the whole of coil 21 as viewed from the right.

As illustrated in FIG. 4 and FIG. 5, insulating member 24 is disposed between bobbin 22 and yoke 25. Insulating member 24 is located between coil 21 and yoke 25. Insulating member 24 insulates between coil 21 and yoke 25. Insulating member 24 covers coil 21 from the right side. Yoke 25 covers insulating member 24 from the right side.

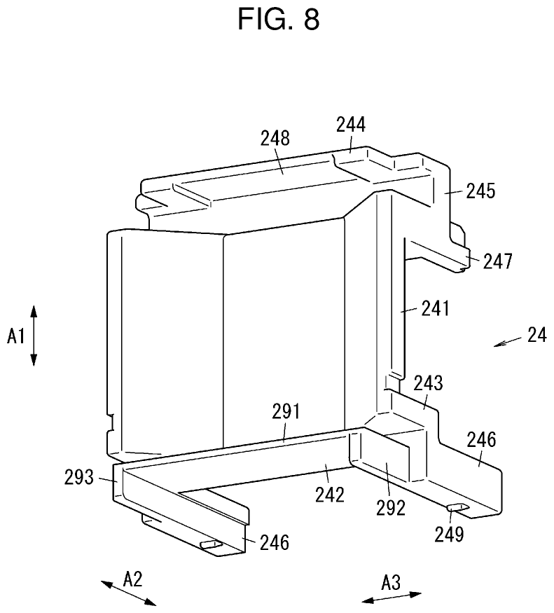

As illustrated in FIG. 5 and FIG. 8, insulating member 24 includes body portion 241, first cover portion 242, first linking portion 243, second cover portion 244, second linking portion 245, a pair of first protrusions 246, and a pair of second protrusions 247. Body portion 241, first cover portion 242, first linking portion 243, second cover portion 244, second linking portion 245, a pair of first protrusions 246, and a pair of second protrusions 247 are integrally formed as a molded body made of a synthetic resin having electrical insulation properties.

Body portion 241 is in the shape of a board having a substantially C shaped cross-section orthogonal to first axis A1. Body portion 241 faces the right side surface of coil 21 and covers coil 21 from the right side. The left surface of body portion 241 includes: a central portion extending in the front-back direction along third axis A3; and opposite end portions extending obliquely forward to the left and obliquely backward to the left so as to incline toward the central portion from ends of the central portion that are opposite along third axis A3, in order to match the curve of the right side surface of coil 21. First yoke 251 covers body portion 241 from the right side.

First cover portion 242 is located below body portion 241. First cover portion 242 is in the shape of a board having a width along second axis A2.

First cover portion 242 covers at least a part of second yoke 252. First cover portion 242 covers at least a part of second yoke 252 from above. First cover portion 242 covers a portion of second yoke 252 that is located near the right end thereof connected to first yoke 251 (refer to FIG. 4). First cover portion 242 includes, as a single unit: upper cover portion 291 that covers the upper surface of second yoke 252; front cover portion 292 that covers the front side surface of second yoke 252; and rear cover portion 293 that covers the rear side surface of second yoke 252. In other words, first cover portion 242 covers second yoke 252 in three directions that are from above, from the front, and from behind. A portion of second yoke 252 at which through-hole 254 is formed is not covered by first cover portion 242 and is exposed from first cover portion 242.

Together with second yoke 252, first cover portion 242 is inserted from the right side into the internal space of lower flange portion 63 of bobbin 22 through opening portion 630.

Lower wall portion 632 of low flange portion 63, second yoke 252, first cover portion 242 of insulating member 24, upper wall portion 631 of low flange portion 63, and coil 21 are arranged in this order from below along first axis A1 in the state where first cover portion 242 and second yoke 252 are inserted into opening portion 630. Therefore, upper wall portion 631 of lower flange portion 63 covers the upper surface of first cover portion 242 from above. Lower wall portion 632 of lower flange portion 63 covers the lower surface of second yoke 252 from below.

First linking portion 243 links body portion 241 and first cover portion 242 together. First linking portion 243 links the lower edge of the right end of body portion 241 and the right end of the upper surface of first cover portion 242 together.

Second cover portion 244 is located above body portion 241. Second cover portion 244 is in the shape of a board having a width along second axis A2.

Second cover portion 244 covers at least a part of the upper surface of upper flange portion 62 (upper flange body 621) of bobbin 22. As illustrated in FIG. 4, second cover portion 244 covers a portion of the upper surface of upper flange body 621 that is located at the right end thereof. Magnetic pole portion 231 of core 23 is exposed and is not covered by second cover portion 244.

Second cover portion 244 includes steps at the left front end and the left rear end as viewed from above. The right end portion of base 641 of first wall portion 64 of upper flange portion 62 and the right end portion of base 651 of second wall portion 65 of upper flange portion 62 fit onto these step portions. As illustrated in FIG. 4, base 641 of first wall portion 64 of upper flange portion 62, third wall portion 66 of upper flange portion 62, base 651 of second wall portion 65 of upper flange portion 62, and second cover portion 244 of insulating member 24 are connected in the shape of a rectangular frame as viewed from above.

As illustrated in FIG. 4, the height position of the upper surface of second cover portion 244 (the position thereof along first axis A1) is substantially equal to the height position of base 641 of first wall portion 64 of upper flange portion 62 and the height position of base 651 of second wall portion 65 of upper flange portion 62.

As illustrated in FIG. 8, recessed portion 248 is formed in the lower surface of second cover portion 244 along second axis A2. Positioning portion 626 of upper flange portion 62 of bobbin 22 fits into recessed portion 248 along second axis A2, and thus insulating member 24 is positioned relative to bobbin 22.

Second linking portion 245 links body portion 241 and second cover portion 244 together. Second linking portion 245 links the upper edge of the right end of body portion 241 and the right end of the lower surface of second cover portion 244 together.

A groove is formed between second cover portion 244, second linking portion 245, and body portion 241 along third axis A3. The right end portion of upper flange body 621 of upper flange portion 62 of bobbin 22 fits into this groove.

The pair of first protrusions 246 protrude to the right from the respective right surfaces of front cover portion 292 and rear cover portion 293 of first cover portion 242 along second axis A2. First protrusion 246 is in the approximate shape of a cuboid extending along second axis A2. Claw 249 protruding downward is formed on the lower surface of first protrusion 246.

The pair of second protrusions 247 protrude to the right from a front end portion and a rear end portion of the upper end on the right surface of body portion 241 along second axis A2. Second protrusion 247 is in an L shape (or an inverted L shape) as viewed from the right side.

### (2.2) Movable Block

As illustrated in FIG. 4 and FIG. 9, movable block 3 includes first movable spring 31, first movable contact member 32, armature 33, and card 4.

First movable spring 31 includes leg piece 35, fixing piece 36, spring piece 37, and movable piece 38. First movable spring 31 includes two leg pieces 35. Two leg pieces 35, fixing piece 36, spring piece 37, and movable piece 38 are integrally formed of an electrically conductive metal material.

Leg piece 35 is in the shape of a rectangular board extending along first axis A1. Two leg pieces 35 are arranged along third axis A3. Leg piece 35 is a terminal that is connected to an external electrical device. As illustrated in FIG. 1, leg piece 35 is exposed on the bottom of case 9.

Fixing piece 36 is in the shape of a board extending upward from the upper end of leg piece 35. Fixing piece 36 is a portion that is fixed to yoke 25, more specifically, first yoke 251. Fixing piece 36 includes two fixing holes 311 into which two fixing protrusions 253 of first yoke 251 are inserted.

Spring piece 37 is in the form of a board in a vertically inverted L-shape as viewed from the front. Spring piece 37 is flexible. Spring piece 37 includes: first leaf spring portion 371 in the shape of a board extending upward from the upper end of fixing piece 36; curved portion 372 curved to the left from the upper end of first leaf spring portion 371; and second leaf spring portion 373 extending to the left from the left end of curved portion 372. First movable spring 31 has, at the center along third axis A3, through-hole 312 extending in the shape of an elongated hole from the upper end of first leaf spring portion 371 to the right end of second leaf spring portion 373 via curved portion 372.

Movable piece 38 is in the shape of a board extending to the left from the left end of second leaf spring portion 373 of spring piece 37. The joint between movable piece 38 and spring piece 37 (second leaf spring portion 373) is bent in a V shape as viewed from the front. Movable piece 38 can move in the up-down direction along first axis A1 according to deflection of spring piece 37. Movable piece 38 is inclined with respect to a normal to fixing piece 36.

Movable piece 38 includes armature holding portion 381 and contact holding portion 382. Armature holding portion 381 is located relatively to the right in movable piece 38. Contact holding portion 382 is located relatively to the left in movable piece 38.

Armature holding portion 381 holds armature 33. In armature holding portion 381, three fixing holes 313 are formed side by side along third axis A3.

Contact holding portion 382 holds first movable contact M1. Contact holding portion 382 has through-hole 314. In first movable spring 31, through-hole 314 is provided in an area that is located relatively rearward along third axis A3. Therefore, the center of through-hole 314 is located rearward of the center of fixing hole 313 that is located at the center among three fixing holes 313.

As illustrated in FIG. 9, armature 33 includes armature body 331, fixing protrusion 332, hook piece 333, and protrusion 334. Armature 33 includes three fixing protrusions 332. Furthermore, armature 33 includes two hook pieces 333. Armature body 331, three fixing protrusions 332, two hook pieces 333, and protrusion 334 are integrally formed of a magnetic material.

Armature body 331 is in the form of a board in the approximate shape of a rectangle as viewed from above. Three fixing protrusions 332 are provided on the upper surface of armature body 331. Three fixing protrusions 332 are provided side by side along third axis A3. Three fixing protrusions 332 of armature 33 are inserted into three fixing holes 313 of armature holding portion 381 of first movable spring 31 from below, and the leading ends of fixing protrusions 332 are smashed; thus, armature 33 is fixed to first movable spring 31 (armature holding portion 381). Armature 33 is positioned below first movable spring 31 and is fixed to first movable spring 31. In other words, first movable spring 31 is fixed to the upper surface of armature 33.

As illustrated in FIG. 2 and FIG. 3, the lower surface of armature 33 faces the upper surface of core 23 (the upper surface of magnetic pole portion 231) in the state where movable block 3 is fixed to electromagnet block 2.

As viewed from above, armature 33 includes first end E1 and second end E2 along second axis A2 crossing first axis A1 (refer to FIG. 9). In the present exemplary embodiment, first end E1 is the left end, and second end E2 is the right end.

Two hook pieces 333 are located at second E2 (the right end) of armature 33. Two hook pieces 333 protrude downward from the front end portion and the rear end portion of the right side surface of armature body 331.

As illustrated in FIG. 3, hook piece 333 is caught on an upper end portion of the right surface of first yoke 251. Therefore, armature 33 rotates at hook piece 333 as a fulcrum according to the presence or absence of the force of attraction between core 23 and armature 33. Movable piece 38 of first movable spring 31 moves in the up-down direction along first axis A1 together with armature body 331.

Protrusion 334 is located at second end E2 (the right end) of armature 33. Protrusion 334 protrudes along the longitudinal axis of armature 33 from a portion of the right side surface of armature body 331 that is at the center thereof along third axis A3 (the portion located between two hook pieces 333). Protrusion 334 is formed in the approximate shape of a cuboid. Protrusion 334 protrudes farther to the right than first movable spring 31 through through-hole 312 of first movable spring 31.

As illustrated in FIG. 9, first movable contact member 32 includes head 321 and body 322.

Head 321 is in the shape of a truncated cone. The axis of head 321 extends along first axis A1. The lower surface of head 321 functions as first movable contact M1. The lower surface of first movable contact member 32 that functions as first movable contact M1 is formed of a silver alloy (AgNi or AgSnO₂), for example. A portion of first movable contact member 32 other than first movable contact M1 is formed of a copper alloy such as touch pitch copper, for example. A surface (the lower surface) of first movable contact member 32 that functions as first movable contact M1 is spherical. Note that the surface (the lower surface) of first movable contact member 32 that functions as first movable contact M1 may be flat or may be dome-shaped.

Body 322 protrudes from the upper end of head 321. Body 322 is inserted in through-hole 314 of contact holding portion 382 of first movable spring 31. First movable contact member 32 is fixed to first movable spring 31 by riveting in the state where body 322 is inserted in through-hole 314 of contact holding portion 382. Thus, first movable contact member 32 is electrically connected to first movable spring 31.

Note that first movable contact M1 may be integrally formed with first movable spring 31. For example, a portion of a metal board included in first movable spring 31 may protrude downward, and the leading end of the protruding portion may be used as first movable contact M1.

In this manner, first movable contact M1 is provided on first movable spring 31, on the side on which first end E1 (the left end) of armature 33 is located, as viewed from above. First movable contact M1 moves in the up-down direction along first axis A1 together with armature body 331 according to movement of armature 33 (rotation at hook piece 333 as a fulcrum).

As illustrated in FIG. 4 and FIG. 9, card 34 is provided on the side on which second end E2 of armature 33 is located, as viewed from above. In the present exemplary embodiment, card 34 is fixed to second end E2 (the right end) of armature 33. More specifically, card 34 is fixed to protrusion 334 of armature 33. Card 34 is, for example, pressed into protrusion 334 of armature 33 and thus fixed thereto.

Card 34 is a molded body made of a synthetic resin having electrical insulation properties. Card 34 moves in the up-down direction along first axis A1 according to movement of armature 33. Card 34 is located on the opposite side of the fulcrum (hook piece 333) of armature 33 from armature body 331 and therefore moves in the direction opposite to the direction of movement of armature body 331. Specifically, card 34 moves downward when armature body 331 moves upward, and card 34 moves upward when armature body 331 moves downward.

As illustrated in FIG. 9, card 34 includes card wall portion 341, tubular portion 342, and protruding portion 343.

Card wall portion 341 is in the shape of a rectangular board. Card wall portion 341 extends along first axis A1. Furthermore, card wall portion 341 extends along third axis A3.

Tubular portion 342 is in the shape of a quadrilateral tube and protrudes to the left from the first surface (the left surface) of card wall portion 341. Card 34 is fixed to armature 33 as a result of protrusion 334 being inserted into tubular portion 342. Tubular portion 342 is fixed to protrusion 334 by pressing, for example.

Protruding portion 343 protrudes to the right from the second surface (the right surface) of card wall portion 341. Specifically, protruding portion 343 is located on the opposite side of card wall portion 341 from a portion (tubular portion 342) of card 34 that is fixed to armature 33. The position at which protruding portion 343 protrudes from card wall portion 341 is different, along first axis A1, from the position at which tubular portion 342 protrudes from card wall portion 341. More specifically, protruding portion 343 protrudes from a position on card wall portion 341 that is located lower than a position thereon from which tubular portion 342 protrudes. Protruding portion 343 is in the shape of a staircase having steps as viewed from the right side. Dome-shaped protrusion 344 protruding upward is provided on the upper surface of protruding portion 343.

### (2.3) First Block

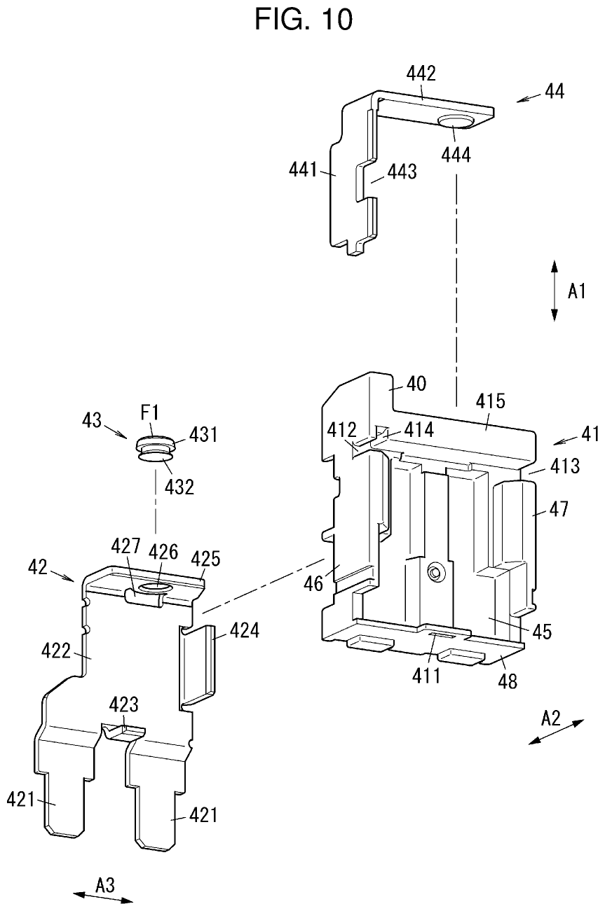

As illustrated in FIG. 3 and FIG. 10, first block 4 includes first holding mount 41, first conductive member 42, first fixed contact member 43, and auxiliary member 44.

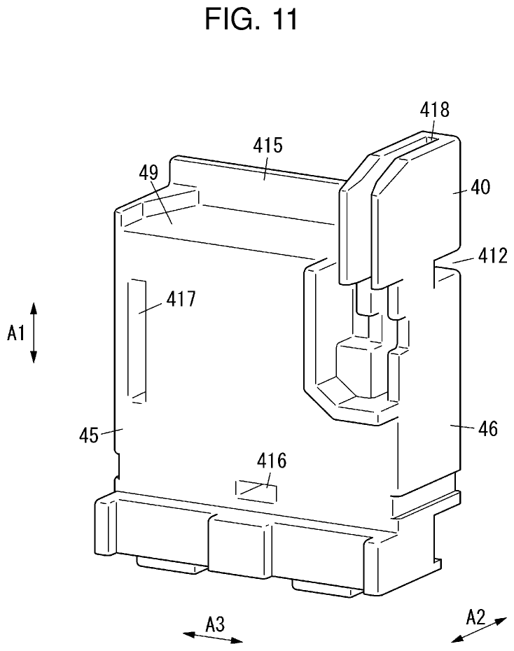

First holding mount 41 is in the shape of a rectangular box that is open on the right side. As illustrated in FIG. 10 and FIG. 11, first holding mount 41 includes left wall 45, front wall 46, rear wall 47, lower wall 48, upper wall 49, and auxiliary wall 40. Left wall 45, front wall 46, rear wall 47, lower wall 48, upper wall 49, and auxiliary wall 40 are integrally formed as a molded body made of a synthetic resin having electrical insulation properties.

Engagement hole 411 is formed in the right end of lower wall 48. Recess 412 depressed to the left along second axis A2 is formed at the upper end of the right side surface of front wall 46. Recess 413 depressed to the left along second axis A2 is formed at the upper end of the right side surface of rear wall 47. Holding groove 414 extending along second axis A2 is formed in a front end portion of the lower surface of upper wall 49.

A front end portion and a rear end portion of protruding board portion 624 of upper flange portion 62 of bobbin 22 are inserted into recess 412 of front wall 46 and recess 413 of rear wall 47. Holding protrusion 625 of upper flange portion 62 of bobbin 22 is inserted into holding groove 414 of upper wall 49. Engagement protrusion 638 of low flange portion 63 of bobbin 22 engages engagement hole 411 of lower wall 48. Thus, body block 10 is combined with first block 4. Left wall 45 of first holding mount 41 faces the left side surface of coil 21 and covers coil 21 from the left side in the state where body block 10 is combined with first block 4 (refer to FIG. 2).

Protruding wall portion 415 protruding upward along first axis A1 is provided on the upper surface of upper wall 49. Protruding wall 415 extends in the front-back direction along third axis A3.

As illustrated in FIG. 11, holding recess 416 depressed to the right is formed in a lower end portion of the left surface of left wall 45. In the left surface of rear wall 47, holding recess 417 depressed to the right is formed along first axis A1.

Auxiliary wall 40 protrudes upward from the upper end of front wall 46. Holding groove 418 extending along first axis A1 is formed in the left surface of first holding mount 41, spanning from auxiliary wall 40 to an upper portion of front wall 46. Holding groove 418 is used to hold auxiliary member 44.

As illustrated in FIG. 10, first conductive member 42 includes leg piece 421, central piece 422, first fixing piece 423, second fixing piece 424, and holding piece 425. First conductive member 42 includes two leg pieces 421. Two leg pieces 421, central piece 422, first fixing piece 423, second fixing piece 424, and holding piece 425 are integrally formed of an electrically conductive metal material.

Leg piece 421 is in the shape of a board extending along first axis A1. Two leg pieces 421 are arranged along third axis A3. Leg piece 421 is a terminal that is connected to an external electrical device. As illustrated in FIG. 1, leg piece 421 is exposed on the bottom of case 9.

Central piece 422 is in the shape of a board extending upward from the upper end of leg piece 421. The right surface of central piece 422 faces the left surface of left wall 45 of first holding mount 41.

First fixing piece 423 is in the shape of a board extending to the right from the lower end of central piece 422 along second axis A2. First fixing piece 423 extends from a portion of the lower end of central piece 422 that is located between two leg pieces 421.

Second fixing piece 424 is in the shape of a board extending to the right from the rear edge of central piece 422 along second axis A2. Second fixing piece 424 extends from a portion of the rear edge of central piece 422 that is at the center thereof along first axis A1.

First fixing piece 423 is inserted into holding recess 416 of first holding mount 41 from the left side. Second fixing piece 424 is inserted into holding recess 417 of first holding mount 41 from the left side. Thus, first conductive member 42 is held on first holding mount 41.

Left wall 45 and protruding wall portion 415 of first holding mount 41 are interposed between first conductive member 42 and coil 21. Therefore, first holding mount 41 is disposed between coil 21 and first conductive member 42 and functions as insulating member 7 that insulates between coil 21 and first conductive member 42.

Holding piece 425 is in the shape of a board having a thickness axis along first axis A1. Holding piece 425 extends to the right from the upper end of central piece 422. Holding piece 425 is located above upper wall 49 of first holding mount 41. Holding piece 425 has through-hole 426 at the center.

First conductive member 42 has through-hole 427 at the joint between central piece 422 and holding piece 425. Therefore, an electric current flowing through holding piece 425 contains not only a component directed along second axis A2, but also a component directed along third axis A3. The electric current component directed along third axis A3 provides the Lorentz force acting in a direction crossing first axis A1 to an electric arc that may be generated between first movable contact M1 and first fixed contact F1 along first axis A1, promoting electric arc extinguishment.

As illustrated in FIG. 10, first fixed contact member 43 includes head 431 and body 432 similar to first movable contact member 32.

Head 431 is in the shape of a truncated cone. The axis of head 431 extends along first axis A1. The upper surface of head 431 functions as first fixed contact F1. The upper surface of first fixed contact member 43 that functions as first fixed contact F1 is formed of a silver alloy (AgNi or AgSnO₂), for example. A portion of first fixed contact member 43 other than first fixed contact F1 is formed of a copper alloy such as touch pitch copper, for example. A surface (the upper surface) of first fixed contact member 43 that functions as first fixed contact F1 is spherical. Note that the surface (the upper surface) of first fixed contact member 43 that functions as first fixed contact F1 may be flat or may be dome-shaped.

Body 432 protrudes from the lower end of head 431. Body 432 is inserted in through-hole 426 of holding piece 425 of first conductive member 42. First fixed contact member 43 is fixed to first conductive member 42 by riveting in the state where body 432 is inserted in through-hole 426 of holding piece 425. Thus, first fixed contact member 43 is electrically connected to first conductive member 42.

Note that first fixed contact F1 may be integrally formed with first conductive member 42. For example, a portion of a metal board included in first conductive member 42 may protrude upward, and the leading end of the protruding portion may be used as first fixed contact F1.

As illustrated in FIG. 2, FIG. 14A, and FIG. 14B, first fixed contact F1 faces first movable contact M1 along first axis A1 in the state where first block 4 is fixed to body block 10. When movable piece 38 of first movable spring 31 moves in the up-down direction, first movable contact M1 moves into and out of contact with first fixed contact F1. Protruding wall portion 415 is interposed between first fixed contact F1 and core 23 (magnetic pole portion 231).

As illustrated in FIG. 10, auxiliary member 44 includes side piece 441 and upper piece 442. Side piece 441 and upper piece 442 are integrally formed of an electrically conductive metal material.

Side piece 441 is in the shape of a board extending along first axis A1. Side piece 441 includes, on the right side surface thereof, recess 443 depressed to the left along second axis A2. With recess 443, auxiliary member 44 is positioned with respect to first holding mount 41 along first axis A1.

Upper piece 442 is in the shape of a board extending backward from the upper end of side piece 441 along third axis A3. On the lower surface of upper piece 442, protrusion 444 protruding farther downward than the remaining portion of upper piece 442 is provided. Protrusion 444 may be formed by pushing, downward from above, a portion of the upper surface of upper piece 442 that corresponds to protrusion 444, for example. The lower surface of protrusion 444 faces the upper surface of body 322 of first movable contact member 32.

Since upper piece 442 of auxiliary member 44 is located above first movable contact member 32, even when first movable spring 31 oscillates at the time of upward movement of first movable spring 31 with first movable contact M1 separating from first fixed contact F1, first movable spring 31 is kept from excessive oscillation.

### (2.4) Second Block

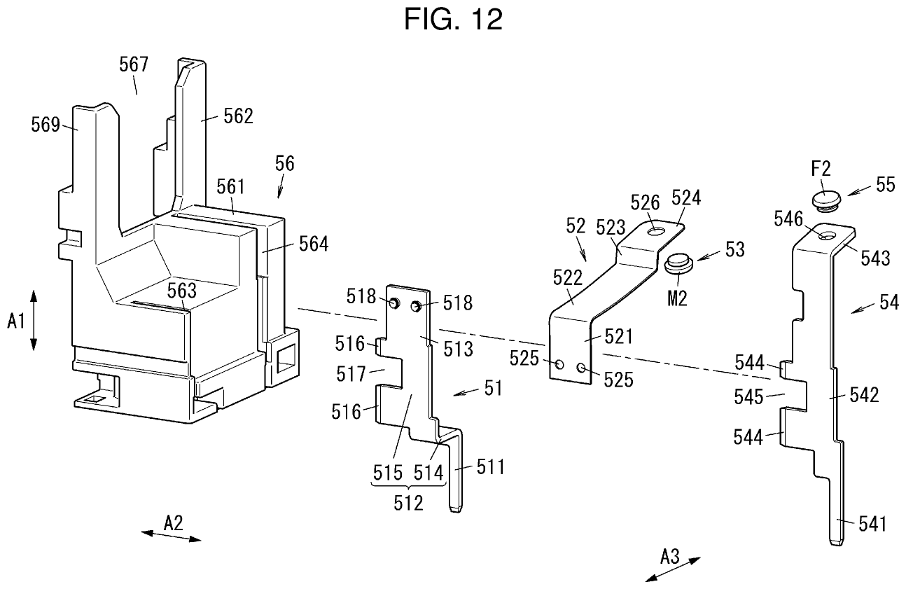

As illustrated in FIG. 3 and FIG. 12, second block 5 includes second conductive member 51, second movable spring 52, second movable contact member 53, third conductive member 54, second fixed contact member 55, and second holding mount 56.

As illustrated in FIG. 12, second conductive member 51 includes leg piece 511, central piece 512, and fixing piece 513. Leg piece 511, central piece 512, and fixing piece 513 are integrally formed of an electrically conductive metal material.

Leg piece 511 is in the shape of a board extending along first axis A1. Leg piece 511 is a terminal that is connected to an external electrical device. As illustrated in FIG. 1, leg piece 511 is exposed on the bottom of case 9.

Central piece 512 is in the form of a board that is L-shaped as viewed from the side and includes: horizontal board portion 514 extending forward from the upper end of leg piece 511; and vertical board portion 515 extending upward from the front end of horizontal board portion 514. The width of vertical board portion 515 (the dimension thereof along second axis A2) is greater than the width of horizontal board portion 514. Two protrusions 516 protruding to the left along second axis A2 are formed on the left side surface of vertical board portion 515. Recess 517 depressed to the right is located between two protrusions 516.

Fixing piece 513 is in the shape of a board extending upward from the upper end of vertical board portion 515 of central piece 512. Fixing piece 513 includes, on an upper end portion of the front surface thereof, two fixing protrusions 518 for fixing second movable spring 52. Fixing protrusions 518 may be formed by pushing, forward from behind, a portion of the rear surface of fixing piece 513 that corresponds to fixing protrusion 518, for example.

As illustrated in FIG. 12, second movable spring 52 includes fixing piece 521, spring piece 522, rising piece 523, and holding piece 524. Fixing piece 521, spring piece 522, rising piece 523, and holding piece 524 are integrally formed of an electrically conductive metal material.

Fixing piece 521 is in the shape of a board extending along first axis A1. Fixing piece 521 is a portion that is fixed to second conductive member 51. Fixing piece 521 has two fixing holes 525 into which two fixing protrusions 518 of second conductive member 51 are inserted. Two fixing protrusions 518 are inserted into two fixing holes 525, and the leading ends of fixing protrusions 518 are smashed; thus, second movable spring 52 is fixed to second conductive member 51.

Spring piece 522 is in the shape of a board extending obliquely upward and backward from the upper end of fixing piece 521. Spring piece 522 is flexible. Spring piece 522 is inclined with respect to a normal to fixing piece 521.

Rising piece 523 is in the shape of a board extending upward from the rear end of spring piece 522. Second movable spring 52 does not need to include rising piece 523. However, when second movable spring 52 includes rising piece 523, it is possible to increase the contact pressure between second movable contact M2 and second fixed contact F2 in the state where second movable contact M2 is in contact with second fixed contact F2.

Holding piece 524 is in the shape of a board extending obliquely upward and backward from the upper end of rising piece 523. Holding piece 524 has through-hole 526.

Holding piece 524 is inclined with respect to a normal to fixing piece 521. The tilt angle of holding piece 524 is substantially equal to the tilt angle of spring piece 522. Holding piece 524 can move in the up-down direction according to deflection of spring piece 522.

Second movable contact member 53 is formed in the approximate shape of a cylinder from a contact material primarily composed of silver, for example. The lower surface of second movable contact member 53 functions as second movable contact M2. The lower surface of second movable contact member 53 that functions as second movable contact M2 is spherical. Note that the surface (the lower surface) of second movable contact member 53 that functions as second movable contact M2 may be flat or may be dome-shaped. Second movable contact member 53 is inserted in through-hole 526 of holding piece 524 of second movable spring 52. Second movable contact member 53 is fixed to second movable spring 52 by riveting in the state where second movable contact member 53 is inserted in through-hole 526 of holding piece 524. Thus, second movable contact member 53 is electrically connected to second movable spring 52.

Note that second movable contact M2 may be integrally formed with second movable spring 52. For example, a portion of a metal board included in second movable spring 52 may protrude downward, and the leading end of the protruding portion may be used as second movable contact M2.

As illustrated in FIG. 12, third conductive member 54 includes leg piece 541, central piece 542, and holding piece 543. Leg piece 541, central piece 542, and holding piece 543 are integrally formed of an electrically conductive metal material.

Leg piece 541 is in the shape of a board extending along first axis A1. Leg piece 541 is a terminal that is connected to an external electrical device. As illustrated in FIG. 1, leg piece 541 is exposed on the bottom of case 9.

Central piece 542 is in the shape of a board extending upward from the upper end of leg piece 541. Two protrusions 544 protruding to the left along second axis A2 are formed on the left side surface of central piece 542. Recess 545 depressed to the right is located between two protrusions 544.

Holding piece 543 is in the shape of a board extending obliquely upward and backward from the upper end of central piece 542. Holding piece 543 has through-hole 546.

Holding piece 543 is inclined with respect to a normal to central piece 542. The tilt angle (the acute angle) of holding piece 543, which is less than or equal to 45 degrees, for example, may be less than or equal to 30 degrees or may be less than or equal to 15 degrees. It is sufficient that the tilt angle (the acute angle) of holding piece 543 be greater than or equal to zero degrees. Holding piece 543 is preferably inclined with respect to a normal to central piece 542 from the perspective of preventing second movable contact M2 from being displaced (skid) with respect to second fixed contact F2 at the time when second movable contact M2 comes into contact with second fixed contact F2.

Second fixed contact member 55 is formed in the approximate shape of a cylinder from a contact material primarily composed of silver, for example. The upper surface of second fixed contact member 55 functions as second fixed contact F2. The upper surface of second fixed contact member 55 that functions as second fixed contact F2 is spherical. Note that the surface (the upper surface) of second fixed contact member 55 that functions as second fixed contact F2 may be flat or may be dome-shaped. Second fixed contact member 55 is inserted in through-hole 546 of holding piece 543 of third conductive member 54. Second fixed contact member 55 is fixed to third conductive member 54 by riveting in the state where second fixed contact member 55 is inserted in through-hole 546 of holding piece 543. Thus, second fixed contact member 55 is electrically connected to third conductive member 54.

Note that second fixed contact F2 may be integrally formed with third conductive member 54. For example, a portion of a metal board included in third conductive member 54 may protrude upward, and the leading end of the protruding portion may be used as second movable contact M2.

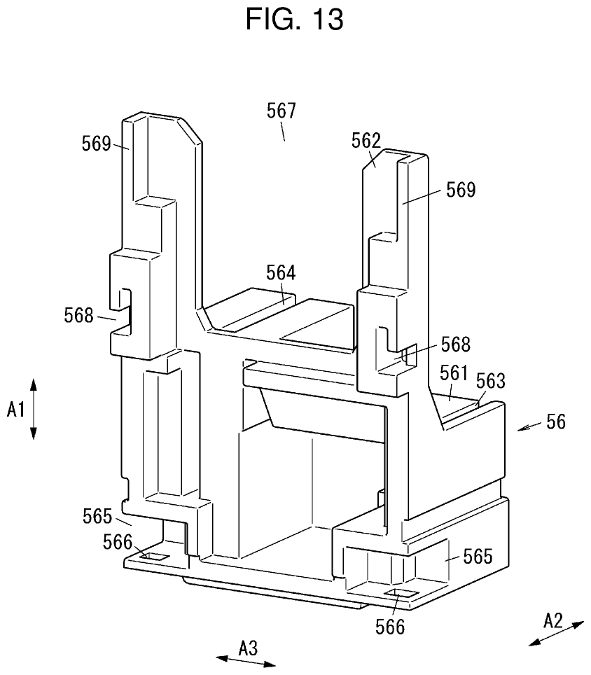

As illustrated in FIG. 12 and FIG. 13, second holding mount 56 includes holding mount body 561 and holding mount wall portion 562.

Holding mount body 561 is formed in the approximate shape of a cuboid. Holding mount body 561 is in the shape of a box that is open on the left side. First holding groove 563 is formed in a front end portion of the right surface of holding mount body 561. Second holding groove 564 is formed in a rear end portion of the right surface of holding mount body 561.

First holding groove 563 is a portion that is used to hold second conductive member 51. First holding groove 563 includes: a first groove portion extending along first axis A1; a second groove portion extending backward from the lower end of the first groove portion; and a third groove portion extending downward from the rear end of the second groove portion. Vertical board portion 515 of central piece 512 of second conductive member 51 fits into the first groove portion. Horizontal board portion 514 of central piece 512 fits into the second groove portion. An upper end portion of leg piece 511 fits into the third groove portion. A portion of the bottom of the first groove portion that corresponds to recess 517 of the left side surface of second conductive member 51 is a protruding pedestal portion that is one step higher, and recess 517 of second conductive member 51 fits with this protruding pedestal portion.

Second holding groove 564 is a portion that is used to hold third conductive member 54. Second holding groove 564 extends along first axis A1. A portion of the bottom of the second groove portion 564 that corresponds to recess 545 of the left side surface of third conductive member 54 is a protruding pedestal portion that is one step higher, and recess 545 of third conductive member 54 fits with this protruding pedestal portion.

As illustrated in FIG. 3, FIG. 15A, and FIG. 15B, second movable contact M2 and second fixed contact F2 face each other in the state where second conductive member 51, second movable spring 52, and third conductive member 54 are held on second holding mount 56. In the present exemplary embodiment, second movable contact M2 is located in an upper area, and second fixed contact F2 is located in a lower area. When holding piece 524 of second movable spring 52 moves in the up-down direction, second movable contact M2 moves into and out of contact with second fixed contact F2.

As illustrated in FIG. 13, a pair of first fitting recesses 565 depressed to the right are formed at a front end portion and a rear end portion of the lower end of the left surface of holding mount body 561. The pair of first protrusions 246 of insulating member 24 of electromagnet block 2 are inserted into the pair of first fitting recesses 565. Engagement hole 566 which claw 249 of first protrusion 246 engages is formed in a lower wall forming the lower surface of first fitting recess 565.

Holding mount wall portion 562 extends upward from the left end of the upper surface of holding mount body 561 along first axis A1. Holding mount wall portion 562 extends along third axis A3. Recess 567 depressed downward from the upper end is formed at a position on holding mount wall portion 562 that is at the center thereof along third axis A3. Recess 567 is formed across substantially the entire length of holding mount wall portion 562 along first axis A1.

A pair of second fitting recesses 568 depressed to the right are formed on a front end portion and a rear end portion of the left surface of holding mount wall portion 562. Second fitting recess 568 is in an L shape (or an inverted L shape) as viewed from the left side. The pair of second protrusions 247 of insulating member 24 of electromagnet block 2 are inserted into the pair of second fitting recesses 568.

In an upper end portion of the left surface of holding mount wall portion 562, ribs 569 protruding to the left are provided along first axis A1, at ends (the front end and the rear end) that are opposite along third axis A3.

### (2.5) Relay Body

Relay body 1 is formed by combining electromagnet block 2, movable block 3, first block 4, and second block 5.

For example, as illustrated in FIG. 4, movable block 3 is positioned to the right of electromagnet block 2. Subsequently, two fixing protrusions 253 of first yoke 251 are inserted into two fixing holes 311 of fixing piece 36 of first movable spring 31 by moving movable block 3 to the left along second axis A2, and the leading ends of fixing protrusions 253 are smashed. Thus, movable block 3 is fixed to electromagnet block 2. This results in body block 10 which is electromagnet block 2 and movable block 3 combined (refer to FIG. 3).

Furthermore, as illustrated in FIG. 3, first block 4 is positioned to the left of body block 10. Subsequently, by moving first block 4 to the right along second axis A2, protruding board portion 624 of upper flange portion 62 of bobbin 22 is inserted into recesses 412, 413 of first holding mount 41, holding protrusion 625 of upper flange portion 62 is inserted into holding groove 414 of first holding mount 41, and engagement protrusion 638 of lower flange portion 63 engages engagement hole 411 of first holding mount 41 (refer to FIG. 7). Thus, first block 4 is fixed to body block 10 (refer to FIG. 2). Note that bobbin 22 may further be fixed to first holding mount 41 by bonding or the like.

Furthermore, as illustrated in FIG. 3, second block 5 is positioned to the right of body block 10. Subsequently, by moving second block 5 to the left along second axis A2, the pair of first protrusions 246 of insulating member 24 are inserted into the pair of first fitting recesses 565 of second holding mount 56, claws 249 engage engagement holes 566, and the pair of second protrusions 247 of insulating member 24 are inserted (in the present exemplary embodiment, pressed) into the pair of second fitting recesses 568 of second holding mount 56. Thus, second block 5 is fixed to body block 10 (refer to FIG. 2). Note that insulating member 24 may further be fixed to second holding mount 56 by bonding or the like.

As described above, electromagnetic relay 100 includes: first terminal mount 81 (bobbin 22 and insulating member 24) that includes bobbin 22 and holds first movable spring 31; second terminal mount 82 (second holding mount 56) that holds second fixed contact F2 and second movable spring 52; and third terminal mount 83 (first holding mount 41) that holds first fixed contact F1. Second terminal mount 82 is separate from first terminal mount 81 and is fixed to first terminal mount 81. Third terminal mount 83 is separate from first terminal mount 81 and second terminal mount 82 and is fixed to first terminal mount 81. In electromagnetic relay 100 according to the present exemplary embodiment, first terminal mount 81, second terminal mount 82, and third terminal mount 83 are separate from each other. Therefore, adjustment of a component held on one terminal mount (for example, second terminal mount 82) (such as component positioning and spring force adjustment) can be made independently of adjustment of components held on the other terminal mounts (for example, first terminal mount 81 and third terminal mount 83). This makes it possible to simplify the manufacturing process of electromagnetic relay 100. Furthermore, it becomes possible to add the second contact device by merely fitting second terminal mount 82 holding the second contact device to first terminal mount 81.

In electromagnetic relay 100 according to the present exemplary embodiment, second terminal mount 82 is fitted to first terminal mount 81 along second axis A2. Third terminal mount 83 is fitted to first terminal mount 81 along second axis A2. In this manner, in electromagnetic relay 100 according to the present exemplary embodiment, second terminal mount 82 and third terminal mount 83 are fitted to first terminal mount 81 along the same axis (second axis A2). This makes it possible to simplify the manufacturing process of electromagnetic relay 100.

One of first terminal mount 81 and second terminal mount 82 (in the present exemplary embodiment, insulating member 24 included in first terminal mount 81) is pressed into the other of first terminal mount 81 and second terminal mount 82 (in the present exemplary embodiment, second holding mount 56 which is second terminal mount 82). This makes it possible to facilitate assembling in the manufacturing process of electromagnetic relay 100.

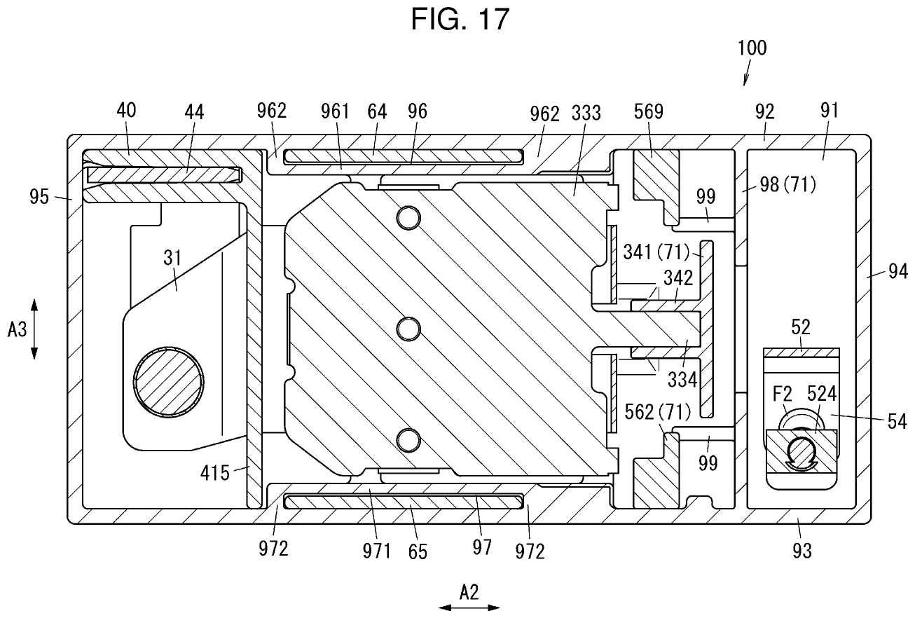

As illustrated in FIG. 2, in relay body 1 of electromagnetic relay 100, card wall portion 341 is disposed between second end E2 (the right end) of armature 33 and second movable spring 52. Furthermore, in relay body 1, holding mount wall portion 562 is disposed between armature body 331 and second movable spring 52. Specifically, for example, as illustrated in FIG. 17, card wall portion 341 and holding mount wall portion 562 are disposed so as to interrupt the shortest distance between a conductive component (hereinafter also referred to as “the first conductive component”) electrically connected to the first contact device and a conductive component (hereinafter also referred to as “the second conductive component”) electrically connected to the second contact device. This allows for an increase in the insulation distance between the first conductive component and the second conductive component. Note that in relay body 1 of electromagnetic relay 100 according to the present exemplary embodiment, the first conductive component includes first movable spring 31, armature 33, and yoke 25. The second conductive component includes second movable spring 52 and third conductive member 54.

In relay body 1 of electromagnetic relay 100 according to the present exemplary embodiment, second movable spring 52 is provided separately from first movable spring 31 and armature 33. Card 34 moves second movable spring 52. Therefore, it is possible to adjust the properties (for example, an overtravel distance) of the second contact device without affecting the properties (for example, an overtravel distance) of the first contact device.

Furthermore, in relay body 1 of electromagnetic relay 100 according to the present exemplary embodiment, as illustrated in FIG. 2, first fixed contact F1 and second fixed contact F2 are located on the opposite sides of the axis of coil 21 along a line connecting first end E1 (the left end) and second end E2 (the right end) of armature 33 as viewed from above. Therefore, the distance between first fixed contact F1 and second fixed contact F2 can be increased. This makes it possible to reduce the likelihood that an electric arc that may be generated at first fixed contact F1 will affect second fixed contact F2 and the likelihood that an electric arc that may be generated at second fixed contact F2 will affect first fixed contact F1, for example.

In relay body 1 of electromagnetic relay 100 according to the present exemplary embodiment, protruding wall portion 415 of first holding mount 41, third wall portion 66 of bobbin 22, and insulating member 24 are located between first fixed contact F1 and second fixed contact F2 along second axis A2. This makes it possible to reduce the likelihood that an electric arc that may be generated at first fixed contact F1 will affect second fixed contact F2 and the likelihood that an electric arc that may be generated at second fixed contact F2 will affect first fixed contact F1, for example.

Next, the operation of relay body 1 (the operation of electromagnetic relay 100) will be described.

In relay body 1, in the state where no voltage is applied between two coil terminals 26 and coil 21 is not energized (hereinafter also referred to as “during de-energization”), first movable contact M1 is separate from first fixed contact F1 by the spring force of first movable spring 31, as illustrated in FIG. 2 and FIG. 14A. Therefore, an electrical circuit (hereinafter also referred to as “the first circuit”) between leg piece 421 of first conductive member 42 and leg piece 35 of first movable spring 31 is interrupted.

During de-energization, second movable contact M2 is in contact with second fixed contact F2 by the spring force of second movable spring 52, as illustrated in FIG. 2 and FIG. 15A. Therefore, an electric circuit (hereinafter also referred to as “the second circuit”) is formed between leg piece 511 of second conductive member 51 and leg piece 541 of third conductive member 54. As illustrated in FIG. 2 and FIG. 15A, protruding portion 343 of card 34 of body block 10 is located below second movable spring 52 of second block 5.

In relay body 1, when a voltage is applied between two coil terminals 26 and coil 21 is energized (hereinafter also referred to as “during energization”), armature 33 is attracted downward toward magnetic pole portion 231 of core 23 along first axis A1 by the force of attraction that is generated between armature 33 and magnetic pole portion 231. Thus, armature 33 rotates at hook piece 333 as a fulcrum (counterclockwise as viewed from the front), and the lower surface of armature 33 comes into contact with the upper surface of magnetic pole portion 231 of core 23. During energization, core 23, yoke 25, and armature 33 form a magnetic circuit through which the magnetic flux generated by coil 21 passes.

During energization, the rotation of armature 33 causes first movable contact M1 to move downward together with armature 33. Thus, during energization, first movable contact M1 comes into contact with first fixed contact F1, as illustrated in FIG. 14B. As a result, the first circuit is formed.

Furthermore, during energization, the rotation of armature 33 causes card 34 to move upward, and protruding portion 343 pushes second movable spring 52 upward. Thus, second movable contact M2 moves out of contact with second fixed contact F2, as illustrated in FIG. 15B. Therefore, the second circuit is interrupted.

As described above, in electromagnetic relay 100 according to the present exemplary embodiment, card 34 includes a lower pressing portion (protruding portion 343) located below second movable spring 52 (refer to FIG. 15A and FIG. 15B). The lower pressing portion pushes second movable spring 52 upward to separate second movable contact M2 from second fixed contact F2. Furthermore, card 34 includes: a base (card wall portion 341 and tubular portion 342); and protruding portion 343 protruding from the base toward a contact device (the second contact device) including second fixed contact F2 and second movable contact M2. Using protruding portion 343, card 34 causes second movable spring 52 to move. When card 34 includes protruding portion 343 that causes second movable spring 52 to move, the insulation distance between the first conductive component and the second conductive component can be increased.

In relay body 1, when the energization of coil 21 stops, the force of attraction between core 23 and armature 33 disappears. Therefore, in relay body 1, armature 33 rotates at hook piece 333 as a fulcrum (clockwise as viewed from the front) by the spring force of first movable spring 31, and armature 33 separates from core 23. The rotation of armature 33 causes first movable contact M1 to move upward together with armature 33 and move out of contact with first fixed contact F1. Thus, the first circuit is interrupted. Furthermore, the rotation of armature 33 causes card 34 to move downward and separate from second movable spring 52. Second movable contact M2 moves downward by the spring force of second movable spring 52 and comes into contact with first fixed contact F1. Thus, the second circuit is formed.

In this manner, in electromagnetic relay 100 according to the present exemplary embodiment, first movable spring 31 can move between a first closed position and a first open position according to switching of coil 21 between the excited state and the non-excited state. The first closed position is the position of first movable spring 31 with first movable contact M1 in contact with first fixed contact F1. The first open position is the position of first movable spring 31 with first movable contact M1 out of contact with first fixed contact F1.

Furthermore, in electromagnetic relay 100 according to the present exemplary embodiment, second movable spring 52 can move between a second closed position and a second open position according to switching of coil 21 between the excited state and the non-excited state. The second closed position is the position of second movable spring 52 with second movable contact M2 in contact with second fixed contact F2. The second open position is the position of second movable spring 52 with second movable contact M2 out of contact with second fixed contact F2. In electromagnetic relay 100 according to the present exemplary embodiment, card 34 causes second movable contact M2 to move into and out of contact with second fixed contact F2 according to switching of coil 21 between the excited state and the non-excited state.

As illustrated in FIG. 14A and FIG. 14B, in relay body 1 (electromagnetic relay 100) according to the present exemplary embodiment, first movable contact M1 moves along first contact axis X1 and moves into and out of contact with first fixed contact F1. Furthermore, as illustrated in FIG. 15A and FIG. 15B, second movable contact M2 moves along second contact axis X2 and moves into and out of contact with second fixed contact F2. Second contact axis X2 extends along first contact axis X1. In the present disclosure, the phrase “second contact axis X2 extends along first contact axis X1” means that the crossing angle (the acute angle) formed between second contact axis X2 and first contact axis X1 is within a predetermined angle range as viewed from the side.

The crossing angle is, for example, 45 degrees or less, may be 30 degrees or less, or may be 15 degrees or less. In electromagnetic relay 100 according to the present exemplary embodiment, since second contact axis X2 extends along first contact axis X1, two contact devices (the first contact device and the second contact device) can be cleaned from the same side (for example, from above) at the time of cleaning with air or the like; thus, cleaning of the two contact devices is facilitated. Furthermore, in electromagnetic relay 100, since second contact axis X2 extends along first contact axis X1, directions in which the two contact devices are vulnerable to oscillations (or impact) are the same; thus, measures can be easily taken against oscillations (or impact). Specifically, in electromagnetic relay 100, directions in which the two contact devices are most vulnerable to oscillations are directions along first axis A1 along which both first contact axis X1 and second contact axis X2 extend. Electromagnetic relay 100 is relatively invulnerable to oscillations along other directions (the direction along second axis A3 and the direction along third axis A3). Therefore, electromagnetic relay 100 can take measures to address oscillations by merely taking measures against oscillation along first axis A1 (for example, providing a buffer material on upper wall 91 of case 9).

Specifically, in the present disclosure, first movable contact M1 faces first fixed contact F1 in the up-down direction as illustrated in FIG. 14A and FIG. 14B, and second movable contact M2 faces second fixed contact F2 in the up-down direction as illustrated in FIG. 15A and FIG. 15B. With this configuration, it is possible to obtain the advantageous effects described above. Note that even when second movable contact M2 does not match second fixed contact F2 in the up-down direction as a whole as illustrated in FIG. 15A and FIG. 15B, second movable contact M2 can be regarded as facing second fixed contact F2 in the up-down direction as long as second movable contact M2 includes a portion facing second fixed contact F2 in the up-down direction. The same applies to the case where these contacts face each other in the left-right direction and the case where these contacts face each other in the front-back direction.

Note that although the present disclosure discloses an exemplary embodiment in which these contacts face each other in the up-down direction, first movable contact M1 may face first fixed contact F1 in the left-right direction, and second movable contact M2 may face second fixed contact F2 in the left-right direction, for example. By setting the direction in which first movable contact M1 faces first fixed contact F1 and the direction in which second movable contact M2 faces second fixed contact F2 to directions that are substantially the same, it is possible to obtain the advantageous effects described above. The same applies to the case where these contacts face each other in the front-back direction.

### (2.6) Case

As illustrated in FIG. 1 and FIG. 2, case 9 houses relay body 1. Therefore, case 9 houses coil 21, core 23, armature 33, first fixed contact F1, first movable spring 31, second fixed contact F2, second movable spring 52, and card 34. Case 9 further houses first terminal mount 81 (bobbin 22 and insulating member 24), second terminal mount 82 (second holding mount 56), and third terminal mount 83 (first holding mount 41). Case 9, which is a molded body made of a synthetic resin having electrical insulation properties, for example, has insulation properties.

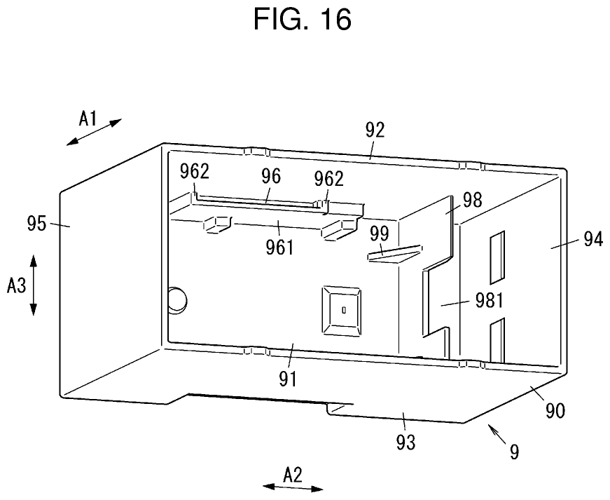

As illustrated in FIG. 1, FIG. 2, and FIG. 16, case 9 includes case body 90. Case body 90 constitutes an outer hull of case 9. Case body 90 is in the shape of a rectangular box with an open bottom. Case body 90 includes upper wall 91, front wall 92, rear wall 93, right wall 94, and left wall 95.

As illustrated in FIG. 16, case 9 further includes first protruding strip portion 961 and two first connecting portions 962 inside case body 90. First protruding strip portion 961 is in the shape of a board extending along first axis A1. First protruding strip portion 961 extends along second axis A2. First protruding strip portion 961 faces front wall 92 with a gap therebetween along third axis A3. Two first connecting portions 962 connect the rear surface of front wall 92 and respective ends of first protruding strip portion 961 that are opposite along second axis A2. Front wall 92, first protruding strip portion 961, and two first connecting portions 962 of case body 90 form first recess 96 which is open at the bottom.

Case 9 further includes second protruding strip portion 971 and two second connecting portions 972 inside case body 90 (refer to FIG. 17). Second protruding strip portion 971 is in the shape of a board extending along first axis A1. Second protruding strip portion 971 extends along second axis A2. Second protruding strip portion 971 faces rear wall 93 with a gap therebetween along third axis A3. Two second connecting portions 972 connect the front surface of rear wall 93 and respective ends of second protruding strip portion 971 that are opposite along second axis A2. Rear wall 93, second protruding strip portion 971, and two second connecting portions 972 of case body 90 form second recess 97 which is open at the bottom.

As illustrated in FIG. 17, first wall portion 64 (more specifically, protruding rib 642) of upper flange portion 62 of bobbin 22 is inserted into first recess 96. Therefore, first protruding strip portion 961 faces first wall portion 64 (more specifically, protruding rib 642) along third axis A3. First connecting portion 962 is inserted into first recessed portion 643. Two first connecting portions 962 are inserted into two respective first recessed portions 643.

As illustrated in FIG. 17, second wall portion 65 (more specifically, protruding rib 652) of upper flange portion 62 of bobbin 22 is inserted into second recess 97. Therefore, second protruding strip portion 971 faces second wall portion 65 (more specifically, protruding rib 652) along third axis A3. Second connecting portion 972 is inserted into second recessed portion 653. Two second connecting portions 972 are inserted into two respective second recessed portions 653.

As illustrated in FIG. 16, case 9 further includes case wall portion 98 inside case body 90. Case wall portion 98 is in the shape of a board extending downward from the lower surface of upper wall 91 of case body 90 along first axis A1. Case wall portion 98 extends along third axis A3 and divides the lower surface of upper wall 91 of case body 90 as the left side and the right side. Recess portion 981 depressed upward is formed at a position on the lower end of case wall portion 98 that is at the center along third axis A3.

As illustrated in FIG. 17, in electromagnetic relay 100, case wall portion 98 is disposed between second end E2 (the right end) of armature 33 and second movable spring 52. Thus, in electromagnetic relay 100, case wall portion 98 can be interposed between the first conductive component and the second conductive component, and the insulation distance between the first conductive component and the second conductive component can be increased. When electromagnetic relay 100 includes both card wall portion 341 and case wall portion 98, the insulation distance between the first conductive component and the second conductive component can be further increased. As illustrated in FIG. 17, card wall portion 341 and case wall portion 98 overlap each other along second axis A2. Furthermore, as illustrated in FIG. 17, at least one of card wall portion 341 and case wall portion 98 extends across the entire length between front wall 92 and rear wall 93 of case body 90 along third axis A3 as viewed from the side. This allows for a further increase in the insulation distance between the first conductive component and the second conductive component.

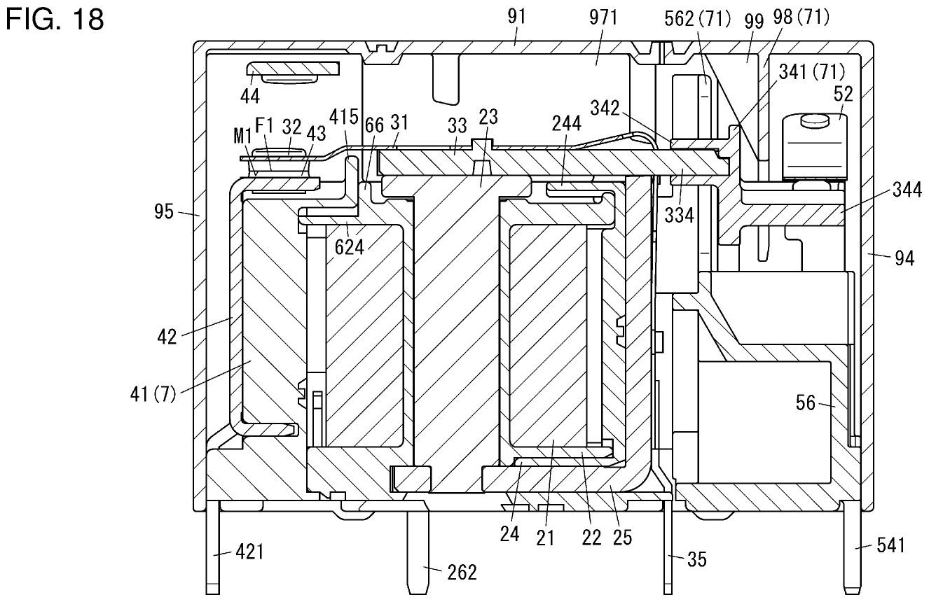

As illustrated in FIG. 17 and FIG. 18, case wall portion 98 is adjacent to card wall portion 341. Case wall portion 98 is located between card wall portion 341 and second movable spring 52 along second axis A2. Therefore, the distance between case wall portion 98 and second movable spring 52 is less than the distance between card wall portion 341 and second movable spring 52. When case wall portion 98 is located between card wall portion 341 and second movable spring 52, even if card 34 is about to come off protrusion 334 of armature 33, card wall portion 341 comes into contact with case wall portion 98 and thus, card 34 is prevented from falling off armature 33. From the perspective of preventing card 34 from falling off, the length of tubular portion 342 of card 34 (the dimension thereof along second axis A2) and the length of protrusion 334 of armature 33 may be greater than the distance between card wall portion 341 and case wall portion 98.

In this manner, electromagnetic relay 100 according to the present exemplary embodiment includes insulating partition wall 71. Insulating partition wall 71 includes at least one of holding mount wall portion 562, card wall portion 341, and case wall portion 98. Insulating partition wall 71 is disposed between yoke 25 and second fixed contact F2. Insulating partition wall 71 is disposed between a conductive portion of first movable spring 31 and second fixed contact F2. The conductive portion of first movable spring 31 is located between coil 21 and second fixed contact F2 as viewed from above and includes, for example, at least one of fixing piece 36 and spring piece 37. Insulating partition wall 71 is located at a position at which the distance between the first conductive component and the second conductive component is shortest. With this, in electromagnetic relay 100, it is possible to further increase the insulation distance between the first conductive component and the second conductive component.

As illustrated in FIG. 16 to FIG. 18, case 9 further includes guide rib 99 inside case body 90. Case 9 includes two guide ribs 99. Guide rib 99 is in the form of a board extending downward from the lower surface of upper wall 91 of case body 90. Guide rib 99 is a slope having a lower side surface inclined from the upper left to the lower right. The right side surface of guide rib 99 is connected to the left surface of case wall portion 98.

As illustrated in FIG. 17, guide rib 99 is formed at a position overlapping holding mount wall portion 562 of relay body 1 as viewed from the side. Guide rib 99 prevents case 9 from being displaced with respect to second holding mount 56 (second terminal mount 82) at the time of fitting case 9 to relay body 1. Specifically, when case 9 is about to be fitted to relay body 1 in the state where case 9 is positioned to the left relative to relay body 1, the lower side surface (the sloped surface) of guide rib 99 comes into contact with an upper side surface of holding mount wall portion 562 of relay body 1. Thus, case 9 is guided so as to move to the right along second axis A2, and the displacement of case 9 with respect to second holding mount 56 (relay body 1) is prevented. When the displacement of case 9 with respect to relay body 1 is prevented, situations where case wall portion 98 contacts card wall portion 341 at the time of fitting case 9 to relay body 1, for example, are avoided.

### (3) Variations

The above-described exemplary embodiment is merely one of various exemplary embodiments of the present disclosure. Various changes can be made to the above-described exemplary embodiment according to the design or the like as long as the object of the present disclosure can be achieved. Variations of the exemplary embodiment will be described below. Hereinafter, there are cases where the above-described exemplary embodiment is referred to as “the basic example.” The above-described basic example and the variations described below can be combined and used, as appropriate.

### (3.1) Variation 1

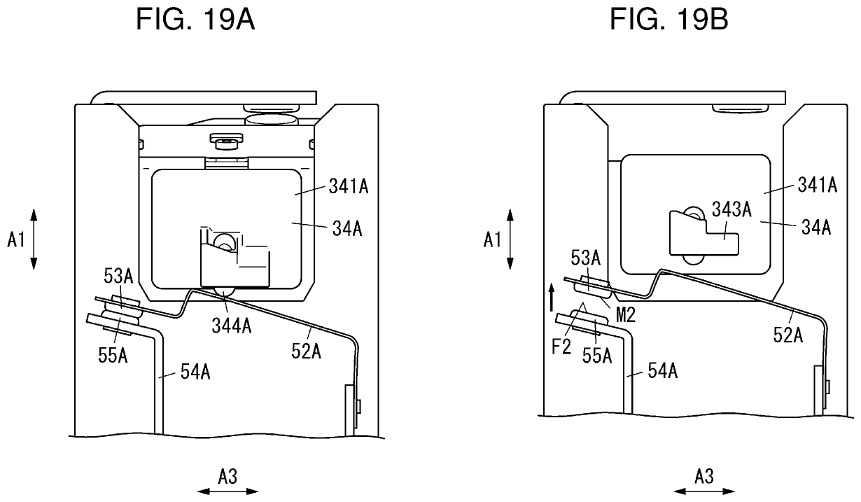

Electromagnetic relay 100 according to the present variation will be described with reference to FIG. 19A and FIG. 19B. There are cases where description of elements that are substantially the same as those of electromagnetic relay 100 in the basic example will be omitted, as appropriate.

Electromagnetic relay 100 in the basic example has a structure (hereinafter also referred to as “a lift-off structure”) in which the contact pressure between second movable contact M2 and second fixed contact F2 is secured by the spring force of second movable spring 52. In contrast, electromagnetic relay 100 according to the present variation has a structure (hereinafter also referred to as “a flexure structure”) in which card 34A pushes second movable spring 52A to secure the contact pressure between second movable contact M2 and second fixed contact F2.

More specifically, card 34A includes card wall portion 341A and protruding portion 343A, as illustrated in FIG. 19A and FIG. 19B. Protruding portion 343A is located above second movable spring 52A. Dome-shaped protrusion 344A protruding downward is provided on the lower surface of protruding portion 343A.

During de-energization, as illustrated in FIG. 19A, protruding portion 343A pushes second movable spring 52A from above, and thus second movable contact M2 on the lower surface of second movable contact member 53A held on second movable spring 52A is in contact with second fixed contact F2 on the upper surface of second fixed contact member 55A held on third conductive member 54A. Thus, the second circuit is formed.

During energization, as illustrated in FIG. 19B, protruding portion 343A moves upward together with card wall portion 341A, and protruding portion 343A separates from second movable spring 52A. Second movable contact M2 moves upward by the spring force of second movable spring 52A, and second movable contact M2 separates from second fixed contact F2.

In this manner, in electromagnetic relay 100 according to the present variation, card 34A includes an upper pressing portion (protruding portion 343A) located above second movable spring 52A, and the upper pressing portion pushes second movable spring 52A downward to bring second movable contact M2 into contact with second fixed contact F2.

Even with electromagnetic relay 100 according to the present variation that has the flexure structure, it is possible to simplify the structure, similar to electromagnetic relay 100 in the basic example.

Note that in the lift-off structure, second movable contact M2 is brought into contact with second fixed contact F2 by the spring force of second movable spring 52, and therefore it is advantageous that the contact pressure is more likely to be stable than in the flexure structure. Furthermore, the lift-off structure has the advantage that the movement of second movable contact M2 into and out of contact with second fixed contact F2 is highly reliable. On the other hand, the flexure structure has the advantage that the contact of second movable contact M2 with second fixed contact F2 is highly reliable.

### (3.2) Variation 2

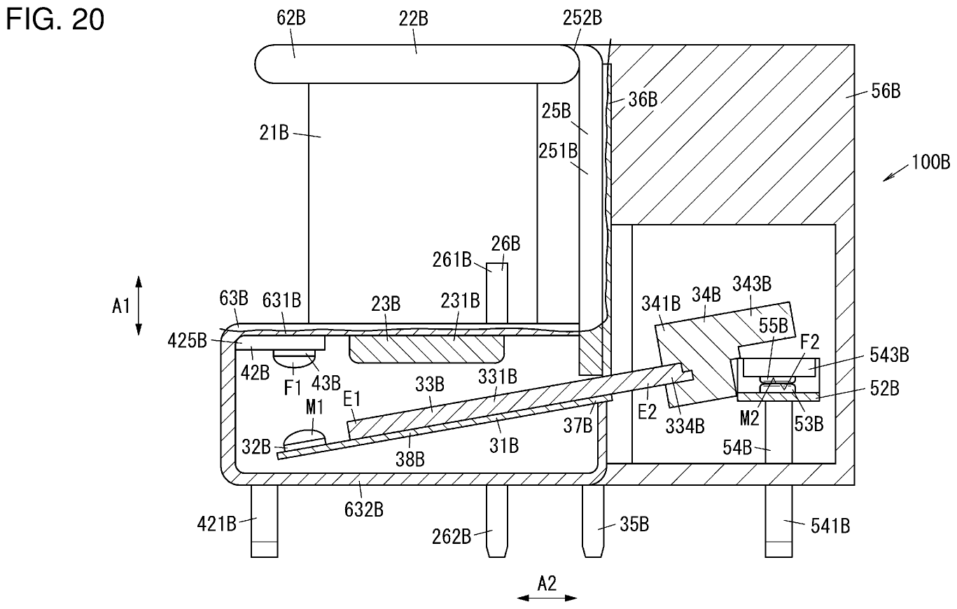

Electromagnetic relay 100B according to the present variation will be described with reference to FIG. 20. There are cases where description of elements that are substantially the same as those of electromagnetic relay 100 in the basic example will be omitted, as appropriate.

Electromagnetic relay 100B according to the present variation is different from electromagnetic relay 100 in the basic example in that first movable contact M1 and first fixed contact F1 are disposed on the side on which lower flange portion 63B of bobbin 22B is located, and the positional relationship between the core and the armature is vertically reversed.

More specifically, in electromagnetic relay 100B according to the present variation, lower flange portion 63B of bobbin 22B is in the shape of a hollow box. First fixed contact F1, first movable contact M1, movable piece 38B of first movable spring 31B, and armature body 331B of armature 33B are disposed in the internal space of lower flange portion 63B.

Coil 21B is wound on bobbin 22B, and two coil terminals 26B are held on lower flange portion 63B of bobbin 22B. First terminal portion 261B of coil terminal 26B protrudes upward from upper wall portion 631B of lower flange portion 63B, and one end of coil 21B is connected to first terminal portion 261B. Second terminal portion 262B of coil terminal 26B protrudes downward from lower wall portion 632B of lower flange portion 63B.

Core 23B is inserted into the body portion of bobbin 22B in the up-down direction along first axis A1 and thus inserted into coil 21B in the up-down direction along first axis A1. Magnetic pole portion 231B of core 23B is exposed in the internal space of low flange portion 63B of bobbin 22B.

First yoke 251B of yoke 25B extends in the up-down direction along first axis A1 and faces the right side surface of bobbin 22B. Second yoke 252B of yoke 25B protrudes to the left from the upper end of first yoke 251B along second axis A2. Second yoke 252B is inserted into upper flange portion 62B of bobbin 22B and connected to the upper end of core 23B.

Holding piece 425B of first conductive member 42B is fixed to the lower surface of upper wall portion 631B of lower flange portion 63B of bobbin 22B. First fixed contact member 43B having a lower surface that functions as first fixed contact F1 is held on the lower surface of holding piece 425B. Leg piece 421B of first conductive member 42B protrudes downward from lower flange portion 63B.

First movable spring 31B includes leg piece 35B, fixing piece 36B, spring piece 37B, and movable piece 38B as a single unit. First movable spring 31B is, for example, in a T-shape rotated 90 degrees as viewed from the front. Leg piece 35B protrudes downward from lower flange portion 63B of bobbin 22B. Fixing piece 36B is fixed to the right surface of first yoke 251B. Movable piece 38B is connected to fixing piece 36B via spring piece 37B and extends obliquely downward to the left from spring piece 37B.

Armature 33B is fixed to the upper surface of movable piece 38B of first movable spring 31B and faces magnetic pole portion 231B of core 23B along first axis A1.

First movable contact member 32B is fixed to the upper surface of movable piece 38B of first movable spring 31B on the side on which first end E1 (the left end) of armature 33B is located. The upper surface of first movable contact member 32B functions as first movable contact M1 and faces first fixed contact F1.

Card 34B includes card wall portion 341B (a base) and protruding portion 343B. Card 34B is provided on the side on which second end E2 (the right end) of armature 33B is located, and is fixed to protrusion 334B of armature 33B.

Second movable spring 52B extends along the third axis crossing both first axis A1 and second axis A2. Second movable contact member 53B having an upper surface that functions as second movable contact M2 is provided on the upper surface of second movable spring 52B.

Third conductive member 54B is held on second holding mount 56B so that holding piece 543B is located above second movable spring 52B and faces second movable contact member 53B along first axis A1. Second fixed contact member 55B having a lower surface that functions as second fixed contact F2 is provided on the lower surface of holding piece 543B. Leg piece 541B of third conductive member 54B protrudes downward from second holding mount 56B.

Second holding mount 56B holds third conductive member 54B and the second conductive member to which second movable spring 54B is connected. Second holding mount 56B is fixed to bobbin 22B.

In electromagnetic relay 100B, during de-energization where coil 21B is not energized, first movable contact M1 is out of contact with first fixed contact F1 by the spring force of first movable spring 31B. Furthermore, during de-energization, second movable contact M2 is in contact with second fixed contact F2 by the spring force (the upward force) of second movable spring 52B.

In electromagnetic relay 100B, during energization where coil 21B is energized via coil terminal 26B, armature 33B is attracted to core 23B and moves toward core 23B, and first movable contact M1 comes into contact with first fixed contact F1. Furthermore, during energization, card 34B presses second movable spring 52B downward, and second movable contact M2 moves into and out of contact with second fixed contact F2.

As described above, electromagnetic relay 100B according to the present variation includes coil 21B, bobbin 22B, core 23B, armature 33B, first fixed contact F1, first movable spring 31B, second fixed contact F2, second movable spring 52B, and card 34B.

Coil 21B is wound on bobbin 22B. Core 23B is inserted into coil 21B in the up-down direction along first axis A1. Armature 33B has a lower surface (a surface located at the top in FIG. 20) facing the upper surface (a surface located at the bottom in FIG. 20) of core 23B. First movable spring 31B includes first movable contact M1. First movable contact M1 faces first fixed contact F1 along first axis A1 and moves into and out of contact with first fixed contact F1. Second movable spring 52B includes second movable contact M2. Second movable contact M2 faces second fixed contact F2 and moves into and out of contact with second fixed contact F2. Card 34B causes second movable contact M2 to move into and out of contact with second fixed contact F2 according to switching of coil 21B between the excited state and the non-excited state.

First movable spring 31B is fixed to the upper surface (a surface located at the bottom in FIG. 20) of armature 33B. Armature 33B includes first end E1 and second end E2 which are opposite ends as viewed from above. First movable contact M1 is provided on first movable spring 31B, on the side on which first end E1 (the left end in FIG. 20) of armature 33B is located, as viewed from above. Card 34B is provided on the side on which second end E2 (the right end in FIG. 20) of armature 33B is located as viewed from above.

Even with electromagnetic relay 100B according to the present variation, it is possible to simplify the structure.

Note that electromagnetic relay 100B according to the present variation may include an insulating member that is substantially the same as insulating member 24 included in electromagnetic relay 100 in the basic example. Furthermore, electromagnetic relay 100B according to the present variation may include a case that is substantially the same as case 9 included in electromagnetic relay 100 in the basic example.

### (3.3) Other Variations

In one variation, the method for fixing card 34 to armature 33 is not limited to pressing. For example, card 34 may be fixed to armature 33 by simultaneous molding or may be fixed to armature 33 by engagement of a claw and a hole.

In one variation, it is sufficient that card 34 cause second movable contact M2 to move into and out of contact with second fixed contact F2 in conjunction with switching of coil 21 between the excited state and the non-excited state (movement of armature 33), and card 34 does not need to be fixed to armature 33. Card 34 may be disposed at a spatial distance from armature 33 and structured to move by being pushed by armature 33 and push second movable spring 52, for example.

In one variation, card 34 may include both the upper pressing portion and the lower pressing portion. For example, card 34 may include two protruding portions so as to sandwich second movable spring 52 from both sides along first axis A1.

In one variation, the method for fixing second terminal mount 82 to first terminal mount 81 and/or the method for fixing third terminal mount 83 to first terminal mount 81 are not limited to pressing. For example, these may be fixed by bonding, resin welding, or the like.

In one variation, insulating partition wall 71 may include only one or two of holding mount wall portion 562, card wall portion 341, and case wall portion 98. Insulating partition wall 71 is not essential and can be omitted.

In the above-described basic example, the first contact device is what is called a Form A contact (a normally open contact) which interrupts a circuit during de-energization, but this is not limiting. In one variation, the first contact device may be what is called a Form B contact (a normally closed contact) which forms a circuit during de-energization. In one variation, the first contact device may be what is called a Form C contact which includes two first fixed contacts F1 and in which first movable contact M1 comes into contact with different first fixed contacts F1 during energization and during de-energization. When the first contact device is a Form B contact or a Form C contact, the lower surface of protrusion 444 of auxiliary member 44 may be used as first fixed contact F1.

In the above-described basic example, the second contact device is what is called a Form B contact, but this is not limiting. In one variation, the second contact device may be a Form A contact or may be a Form C contact.

### (4) Aspects

As is clear from the exemplary embodiment and variations described above, the present specification discloses the following aspects.

Electromagnetic relay 100 (100B) according to the first aspect includes: coil 21 (21B); bobbin 22 (22B) on which coil 21 (21B) is wound; core 23 (23B) extending in an up-down direction and being inserted into bobbin 22 (22B); armature 33 (33B) disposed above core 23 (23B); first fixed contact F1; first movable spring 31 (31B) including first movable contact M1 facing first fixed contact F1, first movable spring 31 (31B) being configured to cause first movable contact M1 to move into and out of contact with first fixed contact F1; second fixed contact F2; second movable spring 52 (52A, 52B) including second movable contact M2 facing second fixed contact F2, second movable spring 52 (52A, 52B) being configured to cause second movable contact M2 to move into and out of contact with second fixed contact F2; and card 34 (34A, 34B) configured to cause second movable contact M2 to move into contact with second fixed contact F2 or cause second movable contact M2 to move out of contact with second fixed contact F2 according to switching of coil 21 (21B) between an excited state and a non-excited state, wherein first movable spring 31 (31B) is fixed above armature 33 (33B), armature 33 (33B) includes first end E1 and second end E2, first movable spring 31 (31B) includes first end portion 31e1 that is near first end E1 of armature 33 (33B) and second end portion 31e2 that is farther from first end E1 of armature 33 (33B) than first end portion 31e1 is, first movable contact M1 is disposed on first end portion 31e1 of first movable spring 31 (31B), and card (34 (34A, 34B)) is disposed facing second end portion 31e2 of armature 33 (33B).

According to this aspect, the structure can be simplified. Furthermore, the contact pressure between first movable contact M1 and first fixed contact F1 can be increased. Moreover, the distance between first movable contact M1 and second movable contact M2 can be increased, making it possible to reduce the likelihood that an electric arc that may be generated at first movable contact M1 will affect second movable contact M2 and the likelihood that an electric arc that may be generated at second movable contact M2 will affect first movable contact M1, for example.

In electromagnetic relay 100 (100B) according to the second aspect, card 34 (34A, 34B) is fixed to second end E2 of armature 33 (33B).

According to this aspect, the structure can be simplified.

In electromagnetic relay 100 (100B) according to the third aspect, armature 33 (33B) includes protrusion 334 (334B) at second end E2, and card 34 (34A, 34B) is fixed to protrusion 334 (334B) of armature 33 (33B).

According to this aspect, the structure can be simplified.

In electromagnetic relay 100 (100B) according to the fourth aspect, card 34 (34A, 34B) includes protruding portion 343 (343A, 343B) protruding outward, and protruding portion 343 (343A, 343B) of card 34 (34A, 34B) moves second movable spring 52 (52A, 52B).

According to this aspect, the insulation distance between the first contact device including first fixed contact F1 and first movable contact M1 and the second contact device including second fixed contact F2 and second movable contact M2 can be increased.

In electromagnetic relay 100 according to the fifth aspect, in the fourth aspect, protruding portion 343A of card 34A is located above second movable spring 52A, and when protruding portion 343A moves downward, protruding portion 343A presses second movable spring 52A downward, and the second movable contact comes into contact with the second fixed contact.

According to this aspect, at the time of bringing second movable contact M2 into contact with second fixed contact F2, the contact of second movable contact M2 with second fixed contact F2 is highly reliable.

In electromagnetic relay 100 according to the sixth aspect, protruding portion 343 of card 34 is located below second movable spring 52, and when protruding portion 343 moves upward, protruding portion 343 presses second movable spring 52 upward, and second movable contact M2 comes out of contact with second fixed contact F2.

According to this aspect, the contact pressure between second movable contact M2 and second fixed contact F2 is likely to be stable. Furthermore, the movement of second movable contact M2 into and out of contact with the second fixed contact (F2) is highly reliable.

In the electromagnetic relay (100, 100B) according to the seventh aspect, card 34 (34A, 34B) includes card wall portion 341 (341A, 341B) disposed between second end E2 of armature 33 (33B) and second movable spring 52 (52A, 52B).

According to this aspect, the insulation distance between the conductive component including armature 33 (33B) and the conductive component including second movable spring 52 (52A, 52B) can be increased.

Electromagnetic relay 100 according to the eighth aspect further includes: case 9 that is insulative and configured to house coil 21, core 23, armature 33, first fixed contact F1, first movable spring 31, second fixed contact F2, second movable spring 52 (52A), and card 34 (34A), wherein case 9 includes case wall portion 98 disposed between second end E2 of armature 33 and second movable spring 52 (52A) and facing card wall portion 341 (341A).

According to this aspect, the insulation distance between the conductive component including armature 33 and the conductive component including second movable spring 52 (52A) can be increased. Furthermore, the fall-off of card 34 (34A) can be prevented.

In the electromagnetic relay (100, 100B) according to the ninth aspect, an axis of coil 21 (21B) is located between first fixed contact F1 and second fixed contact F2 as viewed from above.

According to this aspect, the distance between first fixed contact F1 and second fixed contact F2 can be increased. This makes it possible to reduce the likelihood that an electric arc that may be generated at first fixed contact F1 will affect second fixed contact F2 and the likelihood that an electric arc that may be generated at second fixed contact F2 will affect first fixed contact F1, for example.

The electromagnetic relay (100, 100B) according to the tenth aspect further includes: yoke 25 configured to form a magnetic circuit of coil 21 together with armature 33 and core 23, wherein an insulating partition wall 71 is disposed between yoke 25 and second fixed contact F2.

According to this aspect, the insulation distance between the conductive component including yoke 25 and the conductive component including second fixed contact F2 can be increased. Insulating partition wall 71 may include at least one of card wall portion 341 (341A, 341B), case wall portion 98, and holding mount wall portion 562, for example.

Electromagnetic relay 100 (100B) according to the eleventh aspect further includes: first terminal mount 81 including bobbin 22 (22B) and configured to hold first movable spring 31 (31B); and second terminal mount 82 configured to hold second fixed contact F2 and second movable spring 52 (52A, 52B), wherein second terminal mount 82 is separate from first terminal mount 81 and is fixed to first terminal mount 81.

According to this aspect, adjustment of a component held on one terminal mount (for example, first terminal mount 81) can be made independently of adjustment of a component held on another terminal mount (for example, second terminal mount 82).

In electromagnetic relay 100 (100B) according to the twelfth aspect, one of first terminal mount 81 and second terminal mount 82 is pressed into the other of first terminal mount 81 and second terminal mount 82.

According to this aspect, the assembly of electromagnetic relay 100 (100B) is facilitated.

Electromagnetic relay 100 according to the thirteenth aspect further includes case 9 that is insulative and configured to house coil 21, core 23, armature 33, first fixed contact F1, first movable spring 31, second fixed contact F2, second movable spring 52, card 34, first terminal mount 81, and second terminal mount 82, wherein case 9 includes guide rib 99 configured to prevent displacement of case 9 with respect to second terminal mount 82.

According to this aspect, it is possible to prevent displacement of case 9 with respect to second terminal mount 82.

Electromagnetic relay 100 according to the fourteenth aspect further includes third terminal mount 83 separate from first terminal mount 81 and second terminal mount 82 and configured to hold first fixed contact F1, wherein third terminal mount 83 is fitted to first terminal mount 81, and second terminal mount 82 is fitted to first terminal mount 81.

According to this aspect, the manufacturing process of electromagnetic relay 100 can be simplified.

In electromagnetic relay 100 (100B) according to the fifteenth aspect, first movable contact M1 faces first fixed contact F1 in the up-down direction, and second movable contact M2 faces second fixed contact F2 in the up-down direction.

According to this aspect, the direction in which first movable contact M1 faces first fixed contact F1 and the direction in which second movable contact M2 faces second fixed contact F2 are substantially the same. Therefore, according to this aspect, the contact devices can be easily cleaned. Furthermore, measures can be easily taken against oscillations.

### (5) Other Aspects

In electromagnetic relay 100 according to another aspect, the distance between case wall portion 98 and second movable spring 52 (52A) is less than the distance between card wall portion 341 (341A) and second movable spring 52 (52A).

According to this aspect, the insulation distance between the conductive component including armature 33 and the conductive component including second movable spring 52 (52A) can be increased. Furthermore, the fall-off of card 34 (34A) can be prevented.

Electromagnetic relay 100 according to yet another aspect further includes case 9. Case 9 is insulative. Case 9 houses coil 21, core 23, armature 33, first fixed contact F1, first movable spring 31, second fixed contact F2, second movable spring 52 (52A), and card 34 (34A). Case 9 includes case wall portion 98. Case wall portion 98 is disposed between second end E2 of armature 33 and second movable spring 52 (52A).

According to this aspect, the insulation distance between the conductive component including armature 33 and the conductive component including second movable spring 52 (52A) can be increased.

In electromagnetic relay 100 according to yet another aspect, first movable spring 31 includes a conductive portion (fixing piece 36, 36B, spring piece 37, 37B) between coil 21 and second fixed contact F2 as viewed from above. Insulating partition wall 71 is disposed between the conductive portion and second fixed contact F2.

According to this aspect, the insulation distance between the conductive component including first movable spring 31 and the conductive component including second fixed contact F2 can be increased.

### REFERENCE SIGNS LIST

100, 100B electromagnetic relay
21, 21B coil
22, 22B bobbin
23, 23B core
24 insulating member
243, 245 linking portion
246 first protrusion
247 second protrusion
25, 25B yoke
251, 251B first yoke
252, 252B second yoke
31, 31B first movable spring
31e1 first end portion
31e2 second end portion
33, 33B armature
334, 334B protrusion
34, 34A, 34B card
341, 341A, 341B card wall portion
342 tubular portion
343, 343A, 343B protruding portion
344, 344A protrusion
36, 36B fixing piece (conductive portion)
37, 37B spring piece (conductive portion)
41 first holding mount
423 first fixing piece
424 second fixing piece
44 auxiliary member
444 protrusion
51 second conductive member
513 fixing piece
516 protrusion
52, 52A, 52B second movable spring
521 fixing piece
522 spring piece
53, 53A, 53B second movable contact member
54, 54A, 54B third conductive member
544 protrusion
56, 56B second holding mount
562 holding mount wall portion
64 first wall portion
641, 651 base
7 insulating member
71 insulating partition wall
81 first terminal mount
82 second terminal mount
83 third terminal mount
9 case
98 case wall portion
99 guide rib
F1 first fixed contact
F2 second fixed contact
M1 first movable contact
M2 second movable contact
A1 first axis
A2 second axis
E1 first end
E2 second end
X1 first contact axis
X2 second contact axis

1. An electromagnetic relay comprising:
a coil;
a bobbin on which the coil is wound;
a core extending in an up-down direction and being inserted into the bobbin;
an armature disposed above the core;
a first fixed contact;
a first movable spring including a first movable contact facing the first fixed contact, the first movable spring being configured to cause the first movable contact to move into and out of contact with the first fixed contact;
a second fixed contact;
a second movable spring including a second movable contact facing the second fixed contact, the second movable spring being configured to cause the second movable contact to move into and out of contact with the second fixed contact; and
a card configured to cause the second movable contact to move into contact with the second fixed contact or cause the second movable contact to move out of contact with the second fixed contact according to switching of the coil between an excited state and a non-excited state, wherein
the first movable spring is fixed on the armature,
the armature includes a first end and a second end,
the first movable spring includes a first end portion that is near the first end of the armature and a second end portion that is farther from the first end of the armature than the first end portion is,
the first movable contact is disposed on the first end portion of the first movable spring, and
the card is disposed facing the second end of the armature.

2. The electromagnetic relay according to claim 1, wherein
the card is fixed to the second end of the armature.

3. The electromagnetic relay according to claim 1, wherein
the armature includes a protrusion at the second end, and
the card is fixed to the protrusion of the armature.

4. The electromagnetic relay according to claim 1, wherein
the card includes a protruding portion protruding outward, and
the protruding portion of the card moves the second movable spring.

5. The electromagnetic relay according to claim 4, wherein
the protruding portion of the card is located above the second movable spring, and
as the protruding portion moves downward, the protruding portion presses the second movable spring downward, and the second movable contact comes into contact with the second fixed contact.

6. The electromagnetic relay according to claim 4, wherein
the protruding portion of the card is located below the second movable spring, and
as the protruding portion moves upward, the protruding portion presses the second movable spring upward, and the second movable contact comes out of contact with the second fixed contact.

7. The electromagnetic relay according to claim 1, wherein
the card includes a card wall portion disposed between the second end of the armature and the second movable spring.

8. The electromagnetic relay according to claim 7, further comprising:
a case configured to house the coil, the core, the armature, the first fixed contact, the first movable spring, the second fixed contact, the second movable spring, and the card, the case being insulative, wherein
the case includes a case wall portion disposed between the second end of the armature and the second movable spring and facing the card wall portion.

9. The electromagnetic relay according to claim 1, wherein
an axis of the coil is located between the first fixed contact and the second fixed contact as viewed from above.

10. The electromagnetic relay according to claim 1, further comprising:
a yoke configured to form a magnetic circuit of the coil together with the armature and the core, wherein
an insulating partition wall is disposed between the yoke and the second fixed contact.

11. The electromagnetic relay according to claim 1, further comprising:
a first terminal mount including the bobbin and configured to hold the first movable spring; and
a second terminal mount configured to hold the second fixed contact and the second movable spring, wherein
the second terminal mount is separate from the first terminal mount and is fixed to the first terminal mount.

12. The electromagnetic relay according to claim 11, wherein
one of the first terminal mount and the second terminal mount is pressed into the other of the first terminal mount and the second terminal mount.

13. The electromagnetic relay according to claim 11, further comprising:
a case configured to house the coil, the core, the armature, the first fixed contact, the first movable spring, the second fixed contact, the second movable spring, the card, the first terminal mount, and the second terminal mount, the case being insulative, wherein
the case includes a guide rib configured to prevent displacement of the case with respect to the second terminal mount.

14. The electromagnetic relay according to claim 11, further comprising:
a third terminal mount separate from the first terminal mount and the second terminal mount and configured to hold the first fixed contact, wherein
the third terminal mount is fitted to the first terminal mount, and
the second terminal mount is fitted to the first terminal mount.

15. The electromagnetic relay according to claim 1, wherein
the first movable contact faces the first fixed contact in the up-down direction, and the second movable contact faces the second fixed contact in the up-down direction.
